(19) United States
(12) Patent Application Publication
(10) Pub. No.: US 2026/0064491 A1
(43) Pub. Date: Mar. 5, 2026

(54) SYSTEMS AND METHODS FOR STATE MAP BASED MODEL INSTANCE LOAD BALANCING

(71) Applicant: Protiviti Inc., Menlo Park, CA (US)

(72) Inventors: Benjamin Richard Arroyo Puzon, II, Pleasanton, CA (US); Changbin Vincent Shin, Walnut Creek, CA (US)

(73) Assignee: Protiviti Inc., Menlo Park, CA (US)

(21) Appl. No.: 19/215,471

(22) Filed: May 22, 2025

Related U.S. Application Data
(60) Provisional application No. 63/687,534, filed on Aug. 27, 2024.

(51) Int. Cl. G06F 9/50

(52) U.S. Cl. CPC G06F 9/5083; G06F 9/5038; G06F 2209/502

(57) ABSTRACT

Disclosed herein are a system, a method and a device for providing a state map based model instance load balancing. A server can receive a request from a device in a region to access an instance of an AI model of a plurality of AI models deployed across regions. The server can maintain an AI model map of AI models based at least on the type of AI model. The server can identify, based at least on the request, the region of the request and the type of AI model requested. The server can determine, using the AI model map, the instance of the type of AI model deployed in the region from the plurality of AI models deployed in the region. The server can provide, based at least on the determination, a response to the request providing access to the instance of the type of AI model.

### CROSS-REFERENCE TO RELATED APPLICATION

This application claims the benefit of, and priority to United States Provisional Patent Application No. 63/687,534, filed August 27, 2024, which is incorporated by reference in its entirety for all purposes.

### FIELD OF DISCLOSURE

The present disclosure is generally related to load balancing of network services, including but not limited to, load balancing of request for use of operating instances of artificial intelligence models.

### BACKGROUND

Network services can utilize various types of service functions, such as artificial intelligence (AI) models, to service requests from various client devices. In some instances, service functions, including AI model services, can be deployed in various geographical locations to more expediently service client devices in various areas. Network services, however, can experience varying network traffic and load, potentially impacting the overall system.

### SUMMARY

When servicing client requests using various AI models, network service providers can utilize multiple instances of the AI models to address the incoming requests. To improve service quality, the network service providers may distribute the operating instances of the AI models across various regions, more expediently addressing the client devices. However, some AI models may be updated differently, resulting in variations in their characteristics or operation. This can make it important for the network service provider to understand which AI model to use for each client request. Moreover, as the number of incoming client requests may vary over time, it can be beneficial for the system to monitor the load on each AI model instance to prevent overburdening. Failure to track these factors can lead to operating inefficiencies, increased delays, or service failures, negatively impacting the user experience.

The technical solutions of this disclosure can overcome these challenges by providing a state map-based AI model instance load balancing. The technical solutions can service incoming client requests based on the geographical relations between the requesting client and the AI model instance, as well as the state of the AI model instance load. The system can maintain an AI model map that tracks each instance of AI models deployed across various regions. Upon receiving a request, the system can identify the region of the request and the type of AI model to use for servicing the request. Using the AI model map maintaining the state of different AI model instances across various service regions, the system can determine the most suitable instance of the AI model in a relevant region and provide access to that identified instance to service the client request. In doing so, the technical solutions can efficiently load balance the requests for the AI model instances, dynamically updating the AI model map based on the status of the instances and prioritizing proximity and model-specific requirements. This approach minimizes inefficiencies, delays, and service failures while improving the user experience.

An aspect of the technical solution is directed to a system. The system can include a server comprising one or more processors. The one or more processors can be configured to receive a request from a device in a region to access an instance of a type of artificial intelligence (AI) model from a plurality of AI models deployed across a plurality of regions. The server can maintain an AI model map of each instance of an AI model of the plurality of AI models in each region of the plurality of regions based at least on the type of AI model. The one or more processors can be configured to identify, based at least on the request, the region of the request and the type of AI model requested. The one or more processors can be configured to determine, using the AI model map, the instance of the type of AI model deployed in the region from the plurality of AI models deployed in the region. The one or more processors can be configured to provide, based at least on the determination, a response to the request providing access the instance of the type of AI model.

The one or more processors can be configured to determine whether the request meets one of a rate of calls for the region and a threshold for number of calls for the region per time period. The one or more processors can be configured to provide access to the instance of the type of AI model deployed in the region based on the determining that the request meets the one of the rate of calls for the region and the threshold for the number of calls for the region per time. The one or more processors can be configured to determine whether the request meets one of a rate of calls for the region and a threshold for number of calls for the region per time period. The one or more processors can be configured to determine to provide access to a second instance of the type of AI model in a second region of the plurality of regions responsive to determining that the request does not meet the one of the rate of the calls for the region and the threshold for the number of calls for the region per time.

The one or more processors can be configured to identify, based on the request, one or more specifications for one or more AI models of the plurality of AI models. The one or more processors can be configured to identify, based on the one or more specifications, the type of AI model requested. The one or more processors can be configured to identify, using the AI model map, one or more regions of the plurality of regions that provide the instance of the type of AI model. The one or more processors can be configured to select, based on the region of the request, from the one or more regions, a region of the instance of the type of AI model to generate the response. The region of the instance of the type of AI model can be selected based at least on a proximity between the region of the request and the region of the instance of the type of AI model.

The one or more processors can be configured to detect a geolocation from which the request is originated. The one or more processors can be configured to identify the region of the request based on the geolocation. The one or more processors can be configured to determine a match between a region of the instance of the type of AI model and the region of the request. The one or more processors can be configured to determine, using the AI map, to provide access to the instance of the type of AI model based on the match. The one or more processors can be configured to validate, using one or more security control policies, the request.

The one or more processors can be configured to receive information on status of a plurality of instances of a plurality of AI models, the plurality of instances comprising the instance. The one or more processors can be configured to update, responsive to the information, the AI model map based on the status of the instances of the AI models in the plurality of regions. The one or more processors can be configured to prioritize the instance of the type of AI model based on a proximity of the region of the request to a region in which the instance of the type of AI model is provided.

The one or more processors can be configured to monitor performance metrics of the plurality of AI models. The one or more processors can be configured to adjust the AI model map according to the performance metrics. The one or more processors can be configured to determine, using the AI models map, the instance of AI model based on the performance metrics. The one or more processors can be configured to determine a number of instances of the type of AI model provided in the plurality of regions. The one or more processors can be configured to determine a number of requests for the number of instances of the type of AI model. The one or more processors can be configured to scale the number of instances of the type of AI model based on the number of requests.

An aspect of the technical solutions is directed to a method. The method can include receiving, by one or more servers, a request from a device in a region to access an instance of a type of artificial intelligence (AI) model from a plurality of AI models deployed across a plurality of regions. The one or more servers can maintain an AI model map of each instance of an AI model of the plurality of AI models in each region of the plurality of regions based at least on the type of AI model. The method can include identifying, by the one or more servers based at least on the request, the region of the request and the type of AI model requested. The method can include determining, by the one or more servers using the AI model map, the instance of the type of AI model deployed in the region from the plurality of AI models deployed in the region. The method can include providing, by the one or more servers based at least on the determination, a response to the request providing access the instance of the type of AI model.

The method can include determining, by the one or more servers, whether the request meets one of a rate of calls for the region and a threshold for number of calls for the region per time period. The method can include providing, by the one or more servers, access to the instance of the type of AI model deployed in the region based on the determining that the request meets the one of the rate of calls for the region and the threshold for the number of calls for the region per time.

The method can include determining, by the one or more servers, whether the request meets one of a rate of calls for the region and a threshold for number of calls for the region per time period. The method can include determining, by the one or more servers, to provide access to a second instance of the type of AI model in a second region of the plurality of regions responsive to determining that the request does not meet the one of the rate of the calls for the region and the threshold for the number of calls for the region per time.

The method can include identifying, by the one or more servers, based on the request, one or more specifications for one or more AI models of the plurality of AI models. The method can include identifying, by the one or more servers, based on the one or more specifications, the type of AI model requested. The method can include identifying, by the one or more servers, using the AI model map, one or more regions of the plurality of regions that provide the instance of the type of AI model. The method can include selecting, by the one or more servers based on the region of the request, from the one or more regions, a region of the instance of the type of AI model to generate the response. The region of the instance of the type of AI model is selected based at least on a proximity between the region of the request and the region of the instance of the type of AI model.

An aspect of technical solutions is directed to a non-transitory computer readable medium storing instructions. The instructions, when executed by one or more processors, can cause the one or more processors to receive a request from a device in a region to access an instance of a type of artificial intelligence (AI) model from a plurality of AI models deployed across a plurality of regions. The one or more processors can access an AI model map of each instance of an AI model of the plurality of AI models in each region of the plurality of regions based at least on the type of AI model. The instructions, when executed by one or more processors, can cause the one or more processors to identify, based at least on the request, the region of the request and the type of AI model requested. The instructions, when executed by one or more processors, can cause the one or more processors to determine, using the AI model map, the instance of the type of AI model deployed in the region from the plurality of AI models deployed in the region. The instructions, when executed by one or more processors, can cause the one or more processors to provide, based at least on the determination, a response to the request providing access the instance of the type of AI model.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein.

FIG. 2 is a block diagram of an example system for providing map based AI model instance load balancing.

FIG. 3 illustrates an example of a flow diagram of a method for providing map based AI model instance load balancing.

FIG. 4A illustrates an example of a flow diagram of a method for implementing security control and request validation in an AI model load balancing system.

FIG. 4B illustrates an example of a flow diagram of a method for implementing request control limit and quota management in an AI model load balancing system.

FIGS. 5A and 5B illustrate examples of flow diagrams of methods for providing state maps for AI model based load balancing, according to some configurations.

FIG. 6 illustrates an example flow diagram of a method for managing AI instance relations to accounts, regions and AI models.

FIG. 7 illustrates an example of a flow diagram of a method for providing compositions and relating AI instances with AI models according to accounts.

FIG. 8 illustrates an example of a flow diagram of a method for updating maps for load balancing of AI model instances.

FIG. 9 illustrates an example of a flow diagram of a method for AI instance routing in the AI model load balancing system.

FIG. 10 illustrates an example of a deployment scenario of a client application for providing AI model instance load balancing.

FIG. 11 illustrates an example of a flow diagram of a method for utilizing AI model load balancing in a course of an automated process.

FIG. 12 illustrates an example of a flow diagram of a method for providing a state map based AI model instance load balancing.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for map based AI model instance load balancing.

### A. Computing and Network Environment

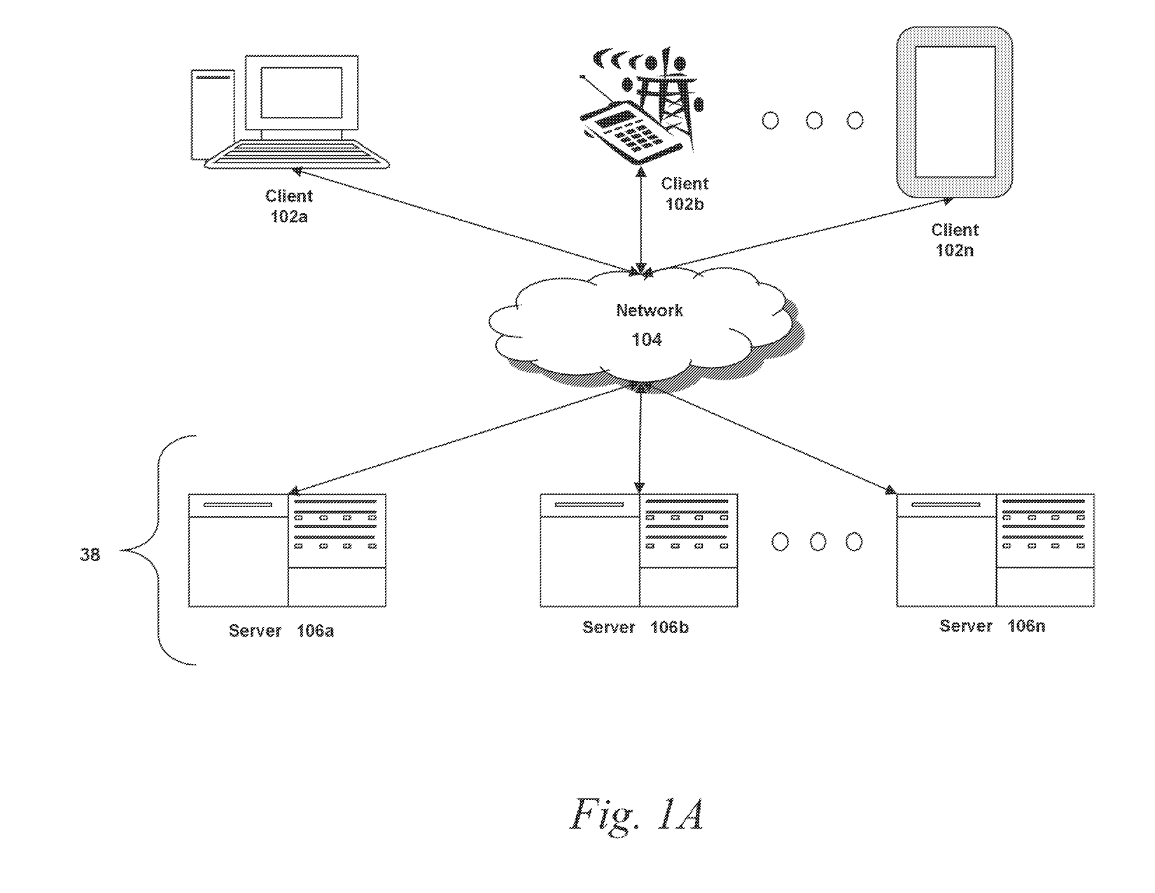

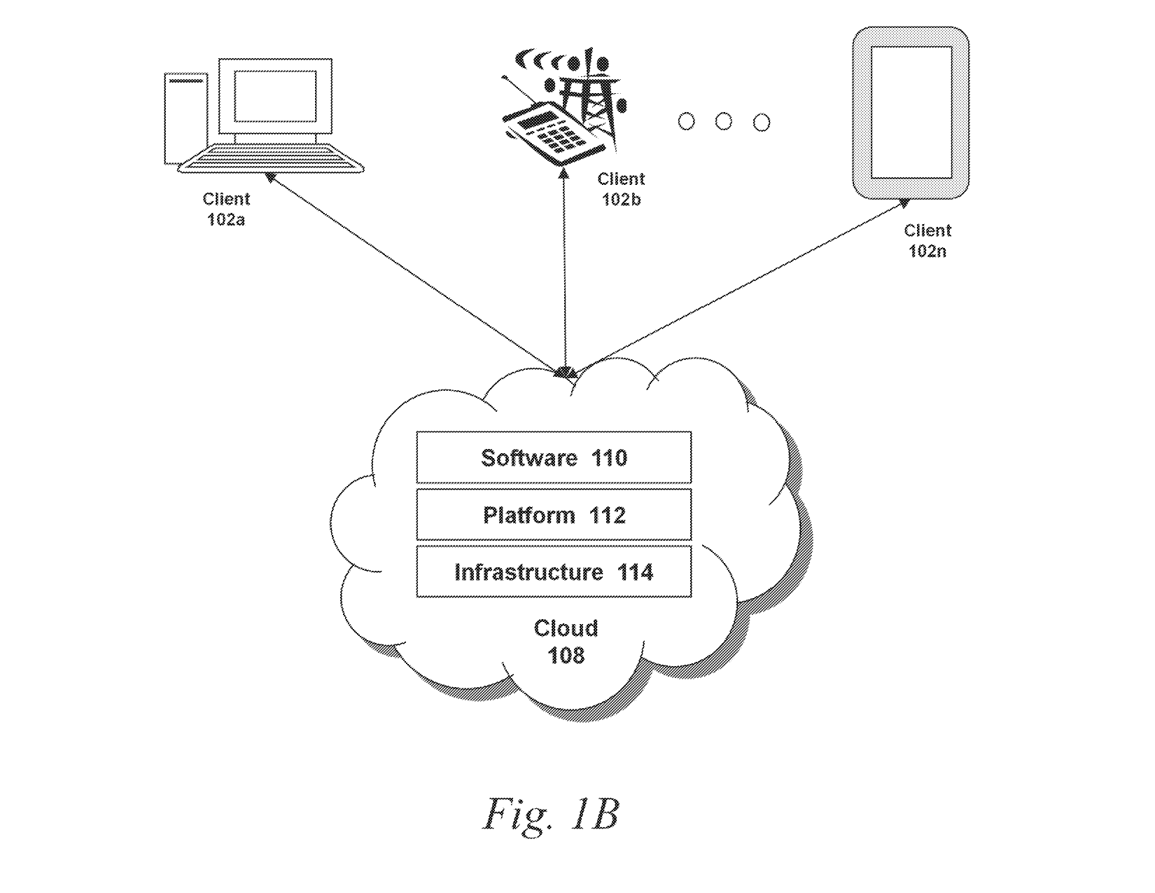

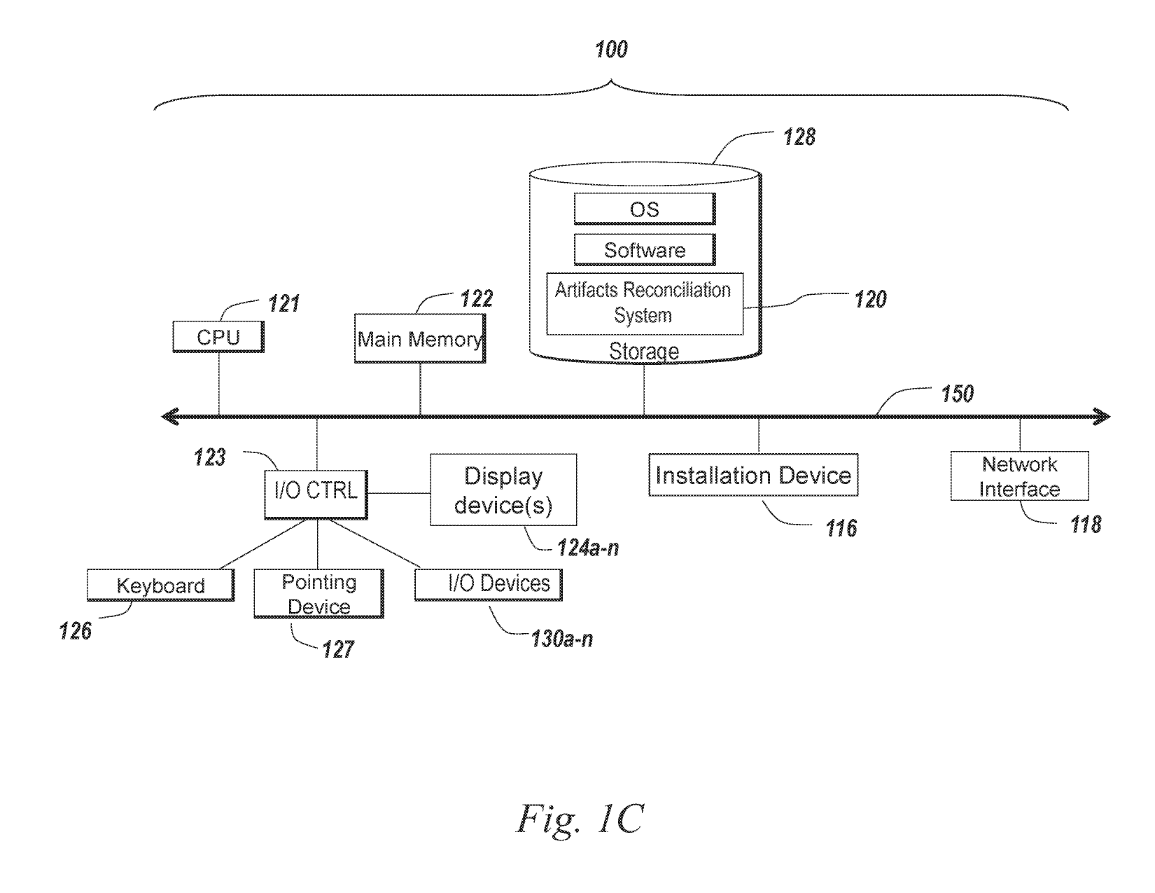

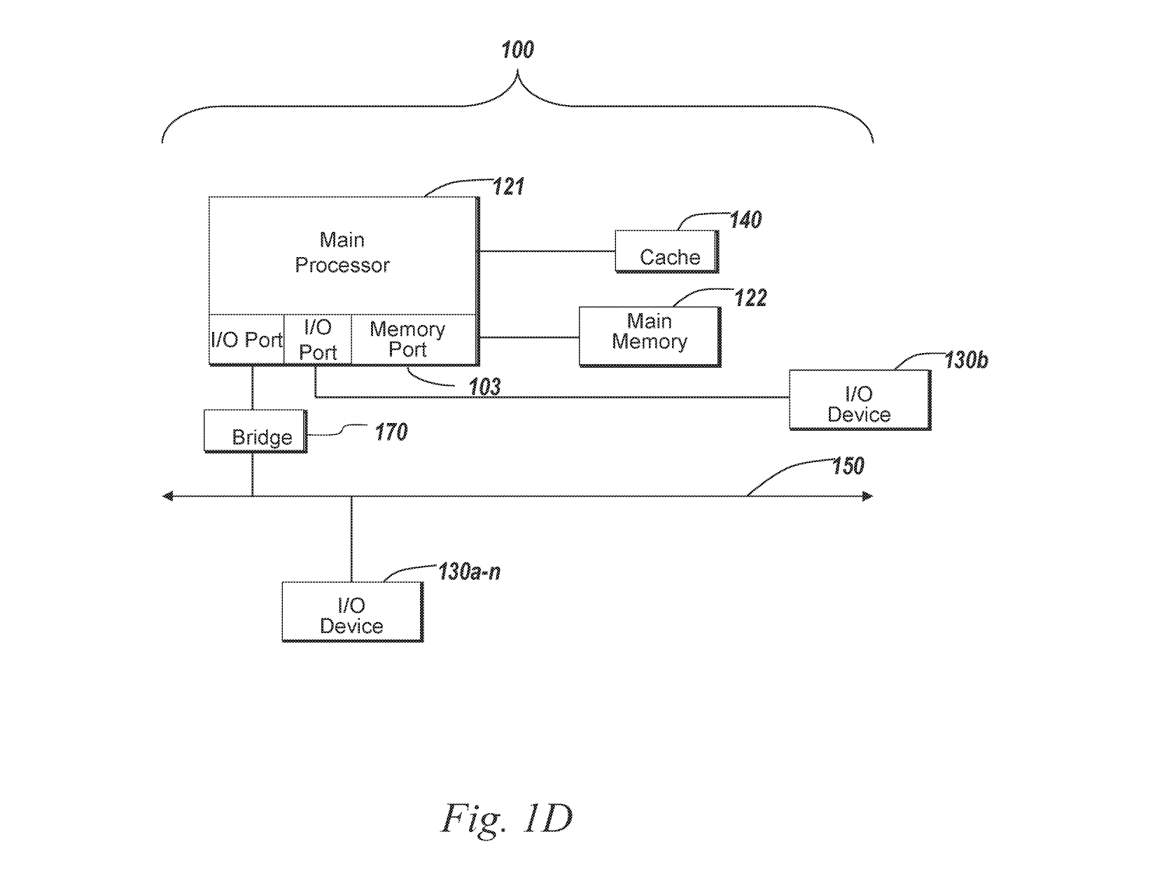

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104’ (not shown) may be a private network and a network 104 may be a public network. In another of these embodiments, a network 104 may be a private network and a network 104’ a public network. In still another of these embodiments, networks 104 and 104’ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104’. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous – one or more of the servers 106 or machines 106 can operate according to one type of operating system platform (e.g., WINDOWS NT, manufactured by Microsoft Corp. of Redmond, Washington), while one or more of the other servers 106 can operate on according to another type of operating system platform (e.g., Unix, Linux, or Mac OS X).

In some embodiments, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, California; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In some embodiments, the server 106 may be referred to as a remote machine or a node. In another embodiment, a plurality of nodes 106 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a data processing system 205. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121’ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In some embodiments, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer’s display device as a second display device 124a for the computing device 100. For example, in some embodiments, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via an I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links ( e.g., 802.11, T1, T3, Gigabit Ethernet, Infiniband), broadband connections ( e.g., ISDN, Frame Relay, ATM, Gigabit Ethernet, Ethernet-over-SONET, ADSL, VDSL, BPON, GPON, fiber optical including FiOS), wireless connections, or some combination of any or all of the above . Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In some embodiments, the computing device 100 communicates with other computing devices 100’ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Florida. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, California; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, California, among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Washington.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Washington. In other embodiments, the computing device 100 is an eBook reader, e.g. the KINDLE family of devices by Amazon.com, or NOOK family of devices by Barnes & Noble, Inc. of New York City, New York.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In some of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Map Based AI Model Instance Load Balancing

Network service providers can face challenges when servicing client requests using various AI models, particularly when the requests are services using various instances of AI models distributed across different geographical regions. While distributing AI model instances across different regions can improve service quality and address client requests more efficiently, any discrepancies in the updates or characteristics of such AI models can complicate the selection of the appropriate model for each request. Additionally, fluctuating rates of client requests over time can make it important to monitor the load on each AI model instance to prevent overburdening. Failure to manage these aspects can lead to inefficiencies, increased delays, or service failures, ultimately degrading the user experience.

The technical solutions can address these challenges through state map-based AI model instance load balancing. This approach involves maintaining an AI model map that tracks each instance of AI models deployed across various regions. When a client request is received, the system identifies the region of the request and the type of AI model suitable. Using the AI model map, the system determines the most suitable instance of the AI model in the relevant region and provides access to this instance. By dynamically updating the AI model map based on the status of the instances and prioritizing proximity and model-specific requirements, the technical solutions allow for efficient load balancing, minimizing inefficiencies, delays, and service failures, thereby enhancing the user experience.

The technical solutions described in this disclosure focus on a state map-based AI model instance load balancing system designed to optimize the handling of client requests for AI services. The system can maintain one or more AI model maps that track the deployment and statuses of AI model instances across various regions. These maps can be used for identifying the most suitable AI model instance to service incoming client requests based on geographical proximity and the current load on each instance.

Upon receiving a client request, the system can parse the request to extract information about the desired AI model and the origin of the request. For example, if a client device in a geographical region requests a specific AI model, the system identifies the region and the type of AI model suitable to handle the request. Using the AI model map, the system locates an available AI model instance in the region or the nearest region with the suitable model. This allows the request to be handled efficiently and promptly, reducing latency and improving the overall user experience.

The technical solutions can also incorporate several levels of control to allow for secure and efficient handling of requests. The levels can include security controls to validate incoming requests, request limit controls to manage the rate of incoming requests, and AI instance and model mapping to accurately match requests with the appropriate AI model instances. For instance, if the particular region is experiencing a high volume of requests, the system can dynamically adjust the AI model map to route some requests to nearby regions with available capacity, thereby balancing the load and preventing service disruptions.

The technical solutions can prioritize regional proximity and model-specific requirements when selecting AI model instances. This means that the system not only considers the geographical location of the request but also the specific characteristics and capabilities of the AI models available in each region. By dynamically updating the AI model map based on real-time data about the status and performance of AI model instances, the technical solutions can allow for the client requests to be reliably serviced by the most efficient AI model instances available.

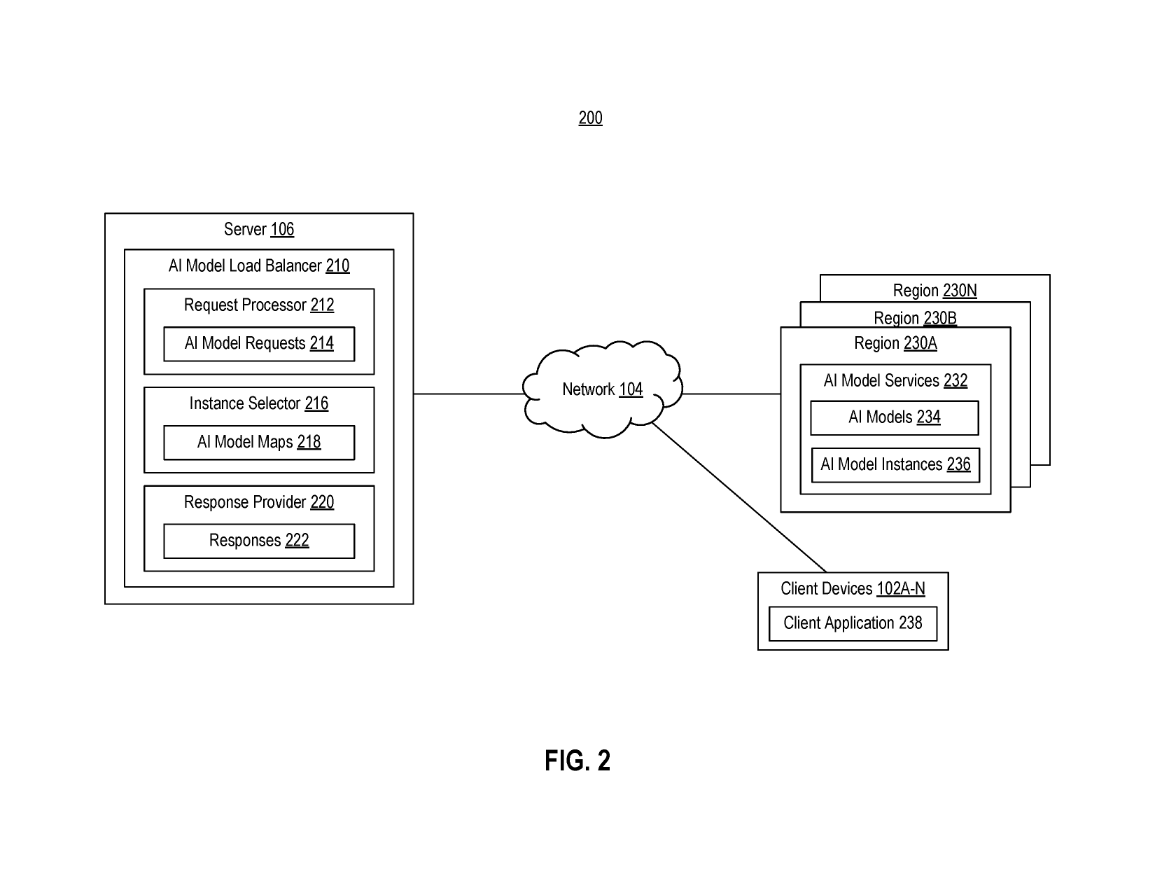

FIG. 2 illustrates an example of a system 200 for providing map based AI model instance load balancing. The example system 200 can include one or more servers 106 communicating, via a network 104, with one or more client devices 102, which can be located within or outside of one or more regions 230. The server 106 can include one or more AI model load balancers 210. Each AI model load balancer 210 can include one or more request processors 212 for receiving and processing AI model requests 214 from client devices 102 to access a particular AI model instance 236 of a type of AI model 234 (e.g., AI model type). The AI model load balancer 210 can include one or more instance selectors 216 for identifying the region 230 from which the AI model request 214 was generated and determining, using one or more AI model maps 218, an available AI model instance 236 of a suitable AI model type 234 deployed in the suitable region 230. The instance selector 216 can select or identify an AI model instance 236 of an AI model 234 based on the characteristics of the AI model 234 identified from the AI model requests 214. The instance selector 216 can identify the AI model instance 236 that is located in the most proximate and available region 230 with respect to the region from which the AI model request 214 was originated. The AI model load balancer 210 can include one or more response providers 220 to provide one or more responses 222 to the AI model request 214 providing access to the selected AI model instance 236.

Across the network 104, the system 100 can include one or more AI model services 232 deployed in one or more regions 230. The AI model services 232 can one or more AI model instances 236 of one or more AI model types 234 to address the AI model requests 214 by various client devices 102. Client devices 102A-N can include any number of devices deployed or located within regions 230A-N, or outside of those regions. The client devices 102 can include or execute one or more client applications 238 configured to issue or transmit AI model requests 214 for processing by the AI models 234. The client applications 238 can have their generated AI model requests 214 intercepted by the server 106 to be processed and load balanced by the AI model load balancer 210, prior to load balancing the requests across AI model instances 236 of AI models 234.

A region 230 can include any area or a region in which AI model services 232 are deployed. The region 230 can include client devices 102 operate. Regions 230 can include any geographical areas or regions (e.g., 230A, 230B or 230N), including one or more one or more towns, counties, states, countries or continents. The region 230 can include various network devices, including servers or cloud-based services providing AI model services 232. Regions 230 can include various client devices 102. Regions 230A-N can be located across the globe. For instance, a North American region 230 may provide AI model instances 236 of the AI models 234 to various AI model requests 214 of the client devices 102 from North America. Similarly, a European region 230 can include another set of same or similar AI model instances 236 for AI models 234 for servicing AI model requests 214 of client devices 102 primarily from European region 230. When AI model instances 236 is not available in the same region 230 as the client device 102 from which the AI model requests 214 was generated, then the AI model load balancer 210 can identify or select a next closest available AI model instance 236 to handle the AI model request 214.

Client devices 102 can include any devices for communicating via a network 104. Client devices 102 can include computers, smartphones, laptops or tablets interacting with AI model services 232 via the server 106 performing AI model instance load balancing via an AI model load balancer 210. Client devices 102 can allow users to enter or generate various requests (e.g., AI model requests 214) which can be addressed using AI model instances 236 of various AI models 234.

Client devices 102 can include or execute one or more client applications 238. A client application 238 can include any application, computer code or program executing on the client device 102 and generating AI model requests 214. The client application 238 can facilitate interaction between the user and the server 106, which in turn can interact with the AI models 234. The client application 238 can generate AI model requests 214 based on user inputs or predefined criteria, and send these requests to the server 106 to be load balanced by the AI model load balancer 210. Upon processing the AI model requests 214, the client application 238 can receive responses 222 generated by the AI model instances 236 selected by the AI model load balancer 210. The client application 238 can process and display these responses 222 on the local user interface (e.g., graphical user interface) of the client device 102. This allows users to seamlessly interact with various AI models 234, receive outputs such as text or content generated by the selected AI model instance, and view the results directly on their device.

In addition to the prior discussed functionalities, the server 106 can include any combination of hardware and software for providing AI model instance load balancing. The server 106 can include or operate using one or more processors 121 based on instructions, information and data stored in memory 122 to implement the functionalities of the AI model load balancer 210. Depending on the configuration, the server 106 can include a single server 106 machine or a plurality of servers 106 distributed or deployed in various regions, such as in each of the regions 230. The server 106 can include a physical or a virtual machine or a cloud based service. The server 106 can receive AI model requests 214 from any number of client devices 102 and can establish connections or sessions with each of the AI model services 232 providing AI model instances 236 of the AI models 234. The server 106 can include and provide any functionality of the AI model load balancer 210 and can operate together with other AI model load balancers 210 that can be provided via other servers 106 to route or load balance the AI model requests 214.

AI model load balancer 210 can include any combination of hardware and software for providing an AI model instance load balancing using a map of operating instances of the AI models. The AI model load balancer 210 can be executed centrally on a single server 106 or can be distributed across a plurality of servers 106. The AI model load balancer 210 can be configured to receive AI model requests 214 from various client devices 102 and provide responses 222 to such requests. The AI model load balancer 210 can maintain or access one or more AI model maps 218 that can maintain the state or status of each individual AI model instance 236 of each AI model 234 across the regions 234A-N. The AI model load balancer 210 can be configured to determine, identify or select individual AI model instances 236 for addressing each of the AI model requests 214, such as by identifying the most suitable AI model instance 236 for the AI model requests 214. For instance, the AI model load balancer 210 can identify, for an incoming AI model request 214, an available AI model instance 236 of an AI model 234 type that is within the same region 230 as the client device 102 that generated the AI model request 214, or alternatively identify an AI model instance 236 in another region 230 (e.g., next most closest or proximate) for an available AI model 234 of the same type of AI model 234.

AI model load balancer 210 include and operate a request processor 212 to receive one or more AI model requests 214 from a client device 102 in a region 230. The AI model request 214 can be a request to access an AI model instance 236 (e.g., an instance of a type of artificial intelligence model) out of plurality of AI models 234 deployed across a plurality of regions 230A-N. The server 106 operating the AI model load balancer 210 can maintain one or more AI model maps 218 which can include information on each AI model instance 236 for each of the AI models 234 in each region 230. The AI model map 218 can be based on, or provide information on, each type of AI model 234 having AI model instances 236 provided by the AI model services 232.

The AI model load balancer 210 can include, execute or operate one or more request processors 212. A request processor 212 can include any combination of hardware and software for receiving and processing AI model requests 214 generated by any client device 102. The request processor 212 can identify, based at least on the request, the region of the request and the type of AI model 234 that is requested. The request processor 212 can identify, based on the AI model request 214, one or more specifications for one or more AI models 234 of the plurality of AI models 234. The specifications can include information or data identifying characteristics or performance parameters of the AI model 234 sought or requested by the request or suitable to adequately respond to the request, such as performance parameters, indication of a type of request or a query or indication of a type of information sought in the response 222. The request processor 212 can operate with the instance selector 216 to determine, select or identify the type of AI model 234 requested or its corresponding AI model instances 236, based on the one or more specifications received in the AI model request 214.

The request processor 212 can receive, parse and review the incoming AI model requests 214 to verify their authenticity, accessibility or validity. For instance, the request processor 212 can validate the AI model request 214 using one or more security control policies or rules. For instance, the request processor 212 can apply the rules based on the access type (e.g., for different types of users) to access different types of AI models 234. The request processor 212 can deny or grant access to an AI model request 214 based on a determination that an access level of the client account (e.g., of the user) associated with the AI model request 214 is sufficient to grant access to the requested type of AI model 234.

An AI model request 214 can include any request to be responded using an AI model 234. The AI model request 214 can be a request by a client device 102 for using an instance of a particular AI model 234. The AI model request 214 can include a query, a question, a text or a string of characters that can be mapped onto or correspond to a particular type of AI model 234. The AI model request 214 can include a request comprising textual content that can be used (e.g., by the instance selector 216) to identify or classify a type of AI model 234 to address the particular query or request by the client device 102.

The AI model request 214 can include characteristics or information that can indicate a query or a request for specific content or type of information or a solution that corresponds to a particular type of AI model 234. The request can be analyzed by the AI model load balancer 210 to determine the type of AI model 234 that is most suitable for addressing the request. For example, the instance selector 216 can use the textual content of the request to identify the characteristics or parameters of the AI model 234 suitable for the request.

The AI model requests 214 can vary in complexity and format and can include structured data, such as JSON or XML, providing data or parameters for the AI model 234 to process. For instance, a request can specify criteria that can be used by the instance selector 216 to identify or select the type of the AI model 234, such as user preferences, historical data, and current context. The instance selector 216 can parse this structured data to identify the type of AI model 234 used to address such a type of request and can select a most appropriate (e.g., geographically closest to the requesting client device or not overburdened AI model instance 236 of that model type). For instance, the AI model requests 214 can be generated in real-time or batch mode. For instance, real-time requests can be processed immediately upon receipt, providing instant responses to client devices 102. Batch mode requests can involve processing large volumes of data over a period, such as overnight analysis of customer feedback for sentiment analysis AI models 234. The instance selector 216 can manage these different types of requests by dynamically allocating AI model instances 236 based on the AI model instance availability and load status.

AI model map 218 can include any type and form of an organized set of data, such as a file, data structure, chart, or a system, which tracks the deployment and status of AI model instances 236 of one or more types of AI models 234 in one or more regions 230. The AI model map 218 can include information about a geographical location or an area, operational status, and specific characteristics of each individual AI model instance 236, AI model 234 or an AI model service 232 at one or more regions 230. The AI model map 218 can include, for example, any one or more indications or information, such as a preferred region 230 to use, an instance affinity towards a particular AI model instance 236, or a fallback model, such as a backup or fallback AI model 234 to utilize in the event the requested or primary AI model 234 is not available. The AI model map 218 can include one or more model aliases, one or more model specific quotas (e.g., rate limit or max quota), or an AI model deployment type. The AI model map 218 can include information for managing and allocating AI model instances 236 to service incoming client requests based on proximity, load, and model-specific requirements.

For example, the AI model map 218 can indicate which AI model instances 236 are available in different regions 230 and their current load status (e.g., number of requests pending for each individual AI model instance 236). When a client device 102 sends an AI model request 214 for a particular AI model 234, the AI model load balancer 210 can refer to the AI model map 218 to identify the most suitable AI model instance 236 to handle the given request. This can involve selecting an AI model instance 236 that is geographically closest to the client device 102 to minimize latency and improve response times.

The AI model map 218 can be dynamically updated based on real-time data about the performance and availability of AI model instances 236. For example, if an AI model instance 236 in one region 230 becomes overloaded with requests (e.g., the number of received AI model requests 214 within a time period exceeds a threshold), the system can select a next geographically closest available AI model instance 236 or update the AI model map 218 to route new requests to other instances in nearby regions with available capacity. Such dynamic updating can be used to facilitate balancing of the load (e.g., incoming requests) across different AI model instances 236 to facilitate an efficient utilization of resources.

The AI model map 218 can include detailed specifications or performance metrics for each AI model instance 236. For instance, the specifications or performance metrics can be used to match client requests with the most appropriate AI model instance 236 based on the specific requirements of the request. For example, if a client request involves complex data analysis, the system can use the AI model map 218 to identify an instance with high computational power and advanced analytical capabilities.

The AI model load balancer 210 can include, execute or operate one or more instance selectors 216. An instance selector 216 can include any combination of hardware and software for identifying, determining or selecting an AI model instance 236 of an AI model 234 type that corresponds to the AI model request 214. The instance selector 216 can determine the AI model instance 236 of the type of AI model 234 deployed in a particular region 230 (e.g., such as the region 230 from which the AI model request 214 was generated). The instance selector 216 can determine or identify the particular AI model instance 236 from the plurality of AI models deployed in the region 230. Determining or identifying the AI model instance 236 for the AI model request 214 can be implemented using an AI model map 218, such as for example based on characteristics or features or features indicative of the type of AI model 234 based on the contents of the AI model request 214.

AI model selector 216 can determine whether the AI model request 214 meets a threshold, such as one of a predetermined rate of calls (e.g., requests) for the region or a threshold for number of calls for the region per time period. The calls can include, for example, application programming interface (API) calls which can serve as the AI model requests 214 identifying the particular types of AI models 234 to access or utilize. The AI model selector 216 can provide access to the AI model instances 236 of the type of AI model 234 deployed in the region 230 of the client device 102 that sent the AI model request 214. This can be done based on the determination (e.g., by the request processor 212 or the instance selector 216) that the request meets the one of the rate of calls for the region and the threshold for the number of calls for the region per time.

The instance selector 216 can determine whether the request meets one of either a rate of calls for the region or a threshold for number of calls for the region per time period, or both, depending on the configuration. The instance selector 216 can determine to provide access to a second (e.g., a different) AI model instance 236 of the type of AI model 234 in a second region 230 of the plurality of regions responsive to determining that the AI model request 214 does not meet the one of the rate of the calls for the region and the threshold for the number of calls for the region per time.

The instance selector 216 can prioritize the AI model instances 236 of the type of AI model 234 based on a proximity of the region 230 of the client device 102 generating the request to a region 230 in which the AI model instance 236 of the requested or matching type of AI model 234 is provided. For example, if an available AI model instance 236 (e.g., the instance whose rate or number of incoming requests does not exceed a threshold) is identified in the same region 230 within which a client device 102 that generated the AI model request 214 is deployed, then this local AI model instance 236 can be selected. For example, if the local AI model instance 236 is not available (e.g., the rate or number of incoming requests meet or exceed the threshold of requests acceptable for the instance), the instance selector 216 can identify or select an AI model instance 236 of the same AI model 234 type in the next geographically closest region 230.

The instance selector 216 can identify, based on the AI model request 214, one or more specifications for one or more AI models 234 of the plurality of AI models. The instance selector 216 can identify, based on the one or more specifications, the type of AI model 234 requested. The instance selector 216 can identify, using the AI model map 218, one or more regions 230 of the plurality of regions that provide the AI model instance 236. The instance selector 216 can select, based on the region 230 of the AI model request 214 (e.g., the region 230 from which the request was generated), a region 230 of the AI model instance 236 of the type of AI model 234 to generate the response 222. The region 230 of the instance (e.g., 236) of the type of AI model 234 can be selected based at least on a proximity (e.g., distance) between the region 230 of the request and the region 230 of the instance of the type of AI model 234.

AI model instances 236 can be associated with a geolocation at which AI model 234 is provided. In some instances, AI model instances 236 are associated with a geolocation from which the AI model request 214 is originated. The AI model load balancer 210 at the server 106 can identify the region 230 of the AI model request 214 based on the geolocation of the request (e.g., location or area associated with the IP address of client device issuing the request). The AI model load balancer 210 can determine a match between a region 230 of the AI model instance 236 of the type of AI model 234 and the region 230 of the request (e.g., the region in which the AI model request 214 is generated by a client device 102). The match can be determined based on the determination that both the client device 102 generating the request and the AI model service 232 providing the AI model instance 236 is within the same region 230. The AI model instance 236 determine, using the AI model map 218, to provide access to the AI model instance 236 of the type of AI model 234 based on the match.

The instance selector 216 can receive information on status of a plurality of AI model instances 236 of a plurality of AI models 234. The plurality of instances can include the AI model instance 236 selected or identified to be used to handle the request 214. The instance selector 216 can update the AI model map 218, responsive to the information on the status. The instance selector 216 can update the AI model map 218 based on the status of the instances of the AI models 234 in the plurality of regions 230. For instance, the instance selector 216 can monitor performance metrics of the plurality of AI models 234 and adjust the AI model map 218 according to the performance metrics. The instance selector 216 can select or determine, using the AI models map 218, the instance of AI model 234 based on the performance metrics.

The performance metrics can include any performance metrics of either an AI model 234 or an AI model instance 236. For example, the performance metrics can include a response time of the AI model instance 216 to client requests, an accuracy rate of the AI model's predictions or outputs, or a processing speed of the AI model 234 or its instance in handling data. The performance metrics can include resource utilization indicating how much computational power and memory the AI model 234 or its instance is using, error rate showing the frequency of incorrect outputs, throughput measuring the number of requests processed in a given time, or latency indicating the delay before the AI model 234 starts processing a request. The performance metrics can include availability showing the uptime of the AI model instance, scalability indicating the AI model's ability to handle increasing amounts of work, and reliability reflecting the consistency of the AI model's performance over time. The instance selector can determine a number of instances of the type of AI model provided in the plurality of regions. The instance selector can determine a number of requests for the number of instances of the type of AI model, and scale the number of instances of the type of AI model based on the number of requests.

The instance selector 216 can determine a number of AI model instances 236 of the type of AI model 234 provided in the plurality of regions 230, and determine the number of AI model requests 214 for these instances of the type of AI model 234. Based on the number of requests, the instance selector 216 can scale the number of instances 236 of the type of AI model 234. For example, if the instance selector 216 can identify that there are ten instances 236 of a specific AI model 234 deployed across various regions 230 and observe that the number of requests for this AI model 234 has significantly increased (e.g., beyond a threshold). The AI model load balancer 210 can then dynamically allocate or initiate additional AI model instances 236 of the AI model 234 to meet the growing demand. Conversely, if the number of requests decreases below a predetermined threshold for the requests for the AI model instances 236, the instance selector 216 can reduce the number of instances 236 to optimize resource utilization. This scaling mechanism can be used to manage the resources in view of the varying loads, maintaining optimal performance and minimizing latency as well as waste of resources.

Response 222 can include any output generated by the system 100 in response to an AI model request 214. The response 222 can include any response provided by an AI model instance 236 of any type of AI model 234. The response 222 can vary based on the nature of the request and the type of AI model 234 used to address the request. The response 222 can be generated using portions of the AI model request 214 as inputs to the AI model instances 236, which can process the inputs to produce the output from the AI model instance 236.

Responses 222 can include acknowledgements, which confirm receipt of the AI model request 214 and indicate that the request is being processed. For example, an acknowledgement can be a message stating that the AI model request 214 was received and is being processed. Response 222 from AI model can be generated by the AI model instance 236 using the inputs provided in the AI model request 214. For instance, if the AI model request 214 includes a query about weather forecasting, information from a database or information about a particular type of topic handled by a particular AI model 234, the AI model instance 236 can process the query and generate a response 222 with the weather forecast for the specified location, the information from the requested database or the information about the particular topic, respectively.

Responses 222 can include informational responses providing information or data related to the AI model request 214. For example, if the AI model request 214 includes data on a recommendation to provide or a determination to make, the response 222 can include the recommendation or determination based on user preferences and historical data. Responses 222 can indicate issues or errors encountered while processing the AI model request 214. For example, if the requested AI model instance 236 is unavailable, the response 222 can include an error message stating that the requested AI model instance is currently unavailable. Response 222 can include status updates providing updates on the progress of processing the AI model request 214. For example, a status update can inform the client device 102 that the request is being processed and provide an estimated time for completion. Results of data analysis can include the results of data analysis performed by the AI model instances 236.

The AI model load balancer 210 can include, operate, or execute one or more response providers 220 to provide responses 222 to the AI model requests 214. A response provider 220 can include any combination of hardware and software for generating and sending a response 222 responsive to the AI model request 214. The response provider 220 can include the functionality to provide a response 222 providing access to the AI model instance 236 of the determined type of AI model 234. For instance, the response provider 220 can provide the response 222 based on a determination or selection of the AI model instance 236 by the instance selector 216 using the AI model map 218.

The response provider 220 can generate any type of responses 222 based on the AI model requests 214. For example, the response provider 220 can generate an acknowledgement response confirming receipt of the AI model request 214 and indicating that the request is being processed. The response provider 220 can generate a response from the AI model instance 236 using the inputs provided in the AI model request 214. For instance, if the request includes a query about weather forecasting, the response provider 220 can process the query and generate a response 222 with the weather forecast for the specified location. The response provider 220 can generate informational responses, such as recommendations based on user preferences and historical data, or error messages indicating issues encountered while processing the AI model request 214. The response provider 220 can provide status updates informing the client device 102 of the progress of the request processing and providing estimated completion times.

AI model services 232 can include any combination of hardware and software for providing AI model instances 236 and AI models 234. AI model services 232 can be executed on one or more servers, such as servers 106, which can be deployed within any of the regions 230. AI model services 232 can include instances of any type and form of AI models 234 AI model services 232 can include various functionalities provided by AI models 234 to address various client requests. The services can include functionalities such as natural language processing, image recognition and predictive analytics. AI model services 232 can be designed to leverage the capabilities of AI models to perform specific tasks. For instance, natural language processing services can analyze and understand human language and can be used to provide applications such as chatbots and virtual assistants to interact with users in a conversational manner. For example, image recognition services can identify and classify objects within images, which can be used in applications such as automated tagging and security surveillance. For example, predictive analytics services can analyze data, such as historical data to forecast future trends, facilitating decision-making processes across various industries.

AI model instances 236 can include any instances of AI models 234 executed on an AI model service 232. AI model instances 236 can include specific deployments of AI models 234 across various regions. As AI models 234 may vary in their version (e.g., due to updates), ai model instances 236 can have different performance based on the type (e.g., version, training or configuration) of the AI model 234. Accordingly, the AI model instances 236 can vary in their configurations and capabilities. The AI model instances 236 can vary depending on the requirements of the client requests and the resources available in each region 230. For example, an AI model instance 236 deployed in a region 230 with high computational resources may be configured to handle complex tasks such as deep learning, while an instance in a region with limited resources may be configured for simpler tasks such as linear regression. The instance selector 216 can dynamically allocate these instances based on the AI model map 218, facilitating efficient and accurate services of client requests 214 by the most suitable and available AI model instance 236 (e.g., the instance that most closely matches the characteristics or parameters of the request and also does not service more than a threshold number of requests per unit of time or rate).

AI model instances 236 can be runtime versions of AI models 234. In the example system 200, a hosting instance, such as an underlying computational host system, can provide or host various AI model instances 236 to service incoming AI model requests 214. AI model instance 236 can be a runtime version of an AI model 234 that is configured within such a hosting instance. The AI model 234 can provide AI model instances 236, such as when a cookie cutter provides instances of cookies. One or more hosting instances can host any AI models 234 that are available to the region in which the hosting instance is located. Accordingly, AI model services 234 can act as AI hosting instances that host AI model instances 236, which are runtime versions of AI models 234 configured within the hosting instance (e.g., a particular Ai model service 233).

AI models 234 can include any type and form of artificial intelligence or machine learning models utilized for responding to AI model requests 214. AI model 234 can include any components of AI services, designed to perform specific tasks based on machine learning or artificial intelligence techniques. AI model 234 can include, combine or utilize any one or more of the various types of AI model functionalities. For instance, AI model 234 can include or utilize supervised learning models which can be used for classification and regression tasks. The AI model 234 can be trained (e.g., via an AI model trainer) to make inferences or determinations based on labeled data in order to, for example, predict outcomes based on input information. AI model 234 can include any architectures for supervised learning, such as decision trees, support vector machines, or neural networks. AI models 234 can be used in, or trained for, any variety of applications, such as spam detection, medical diagnosis, financial forecasting, response to user inquiries on particular or general topics and more.

AI models 234 can include unsupervised learning models configured for clustering and association tasks. For instance, an AI model 234 can be trained to identify patterns in data without labeled outcomes. AI models 234 can include various architectures for unsupervised learning, such as k-means clustering and principal component analysis configured for customer segmentation, anomaly detection, and market basket analysis.

AI models 234 can include reinforcement learning models which can be configured for decision-making tasks, in which the model can learn to make decisions by interacting with an environment and receiving feedback. AI models 234 can include architectures for reinforcement learning, such as Q-learning and deep reinforcement learning. AI models 234 can be used in applications such as robotics, game playing, and autonomous driving. Reinforcement learning models 230 can be used to identify the optimal strategy or optimize one or more tasks that may not be known in advance and that may be discovered through trial and error.

AI models 234 can include or utilize any transformer mechanisms and attention functions, such as for natural language processing. AI models 234 can include transformers including neural network architectures that use self-attention mechanisms to process input data. The attention function can allow the AI model 234 to focus on different parts of the input data, allowing for capturing long-range dependencies and context. The AI model 234 can perform language translation and text summarization of various data. The AI model 234 can include the transformer architecture, such as bidirectional encoder representation from transformers (BERT) and generative pre-trained transformer (GPT), which can be used for natural language processing operations.

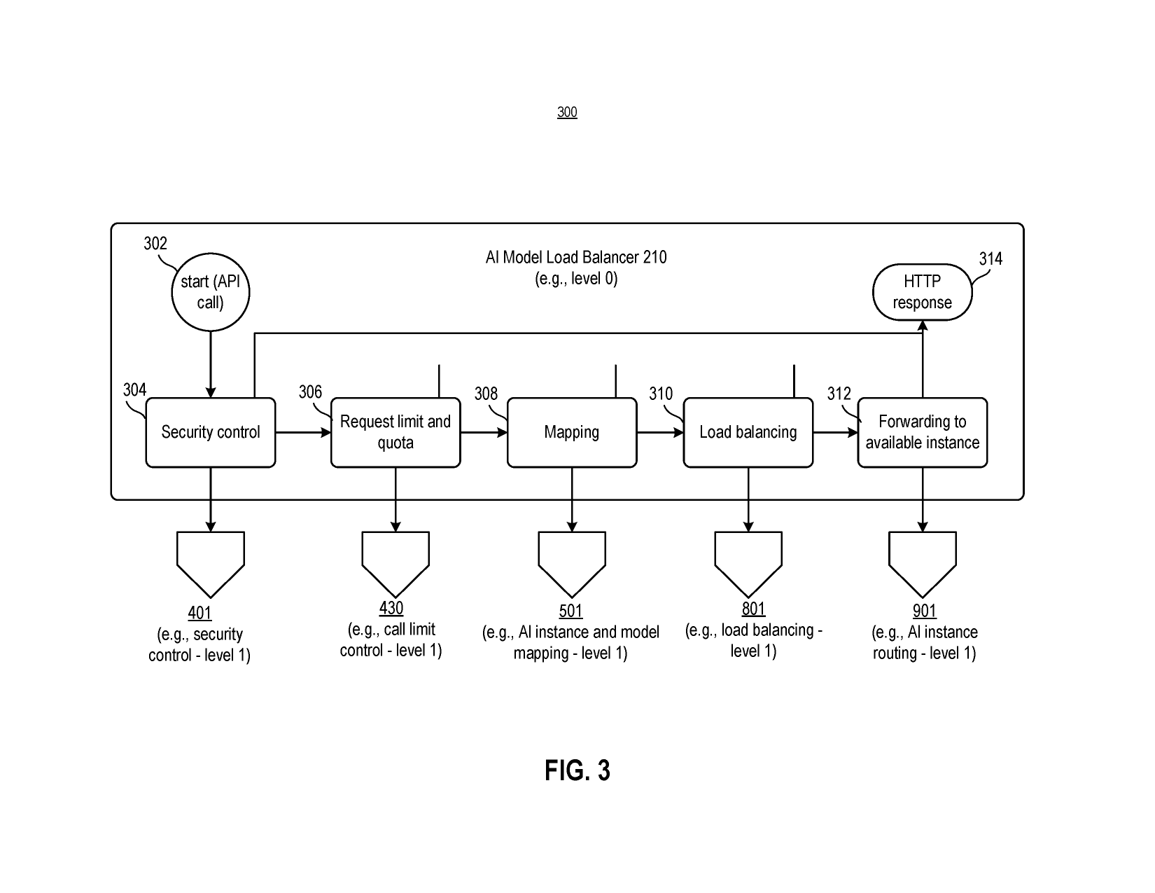

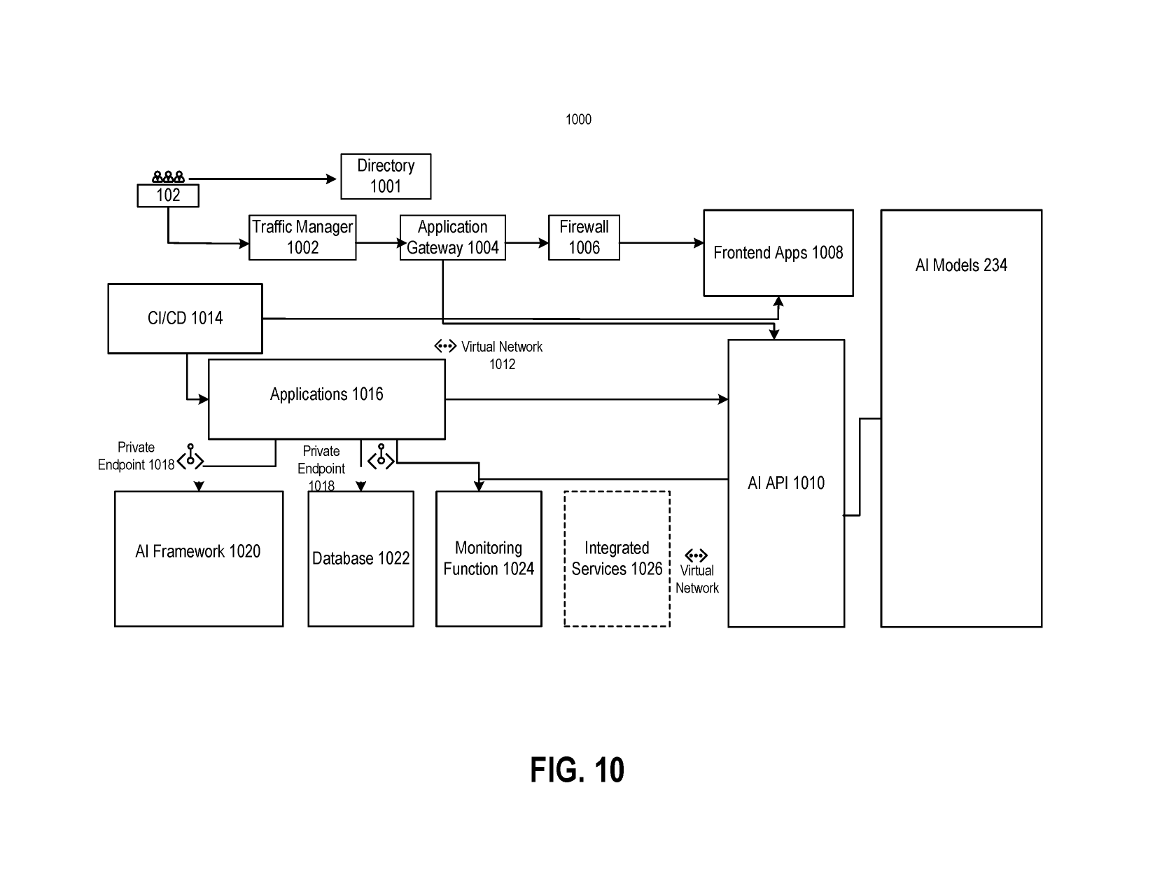

FIG. 3 illustrates an example flow diagram of a method 300 for providing map based AI model instance load balancing. The method 300 can be implemented using any example systems, such as systems described in FIGS. 1A-2 of FIG. 10. The method 300 can be implemented by a server, a cloud-based service or any other service implementing AI model load balancer 210. The method 300 can include steps or operations 302-314 in which the AI model load balancing system can parse an incoming request and extract information about the Al model which the request is looking for and about the origin of the request. The method 300 can locate the available Al service that is close to the requestor, which is not overly used and is suitable for servicing the request as it is associated with the model the request matches. Although the physical Al instances across regions and accounts can be homogeneous, the individual AI models deployed in them may not be. The AI model load balancer may keep track of the deployed AI models in each of the Al instances in all regions and accounts, and be able to load-balance even the heterogeneously deployed models. This can allow the AI model load balancer to continuously add new models as they become available without affecting the users or consuming applications.

At step 302, the method 300 can start the API call. The process can be initiated when a client device triggers an API call with a request for an AI model. The client request can include a query or a message, including textual content, which can be used to trigger or initiate an API call to the AI model load balancer. This call can be received by the AI model load balancer, which can parse the incoming client request to extract information about the requested AI model and the origin of the request.

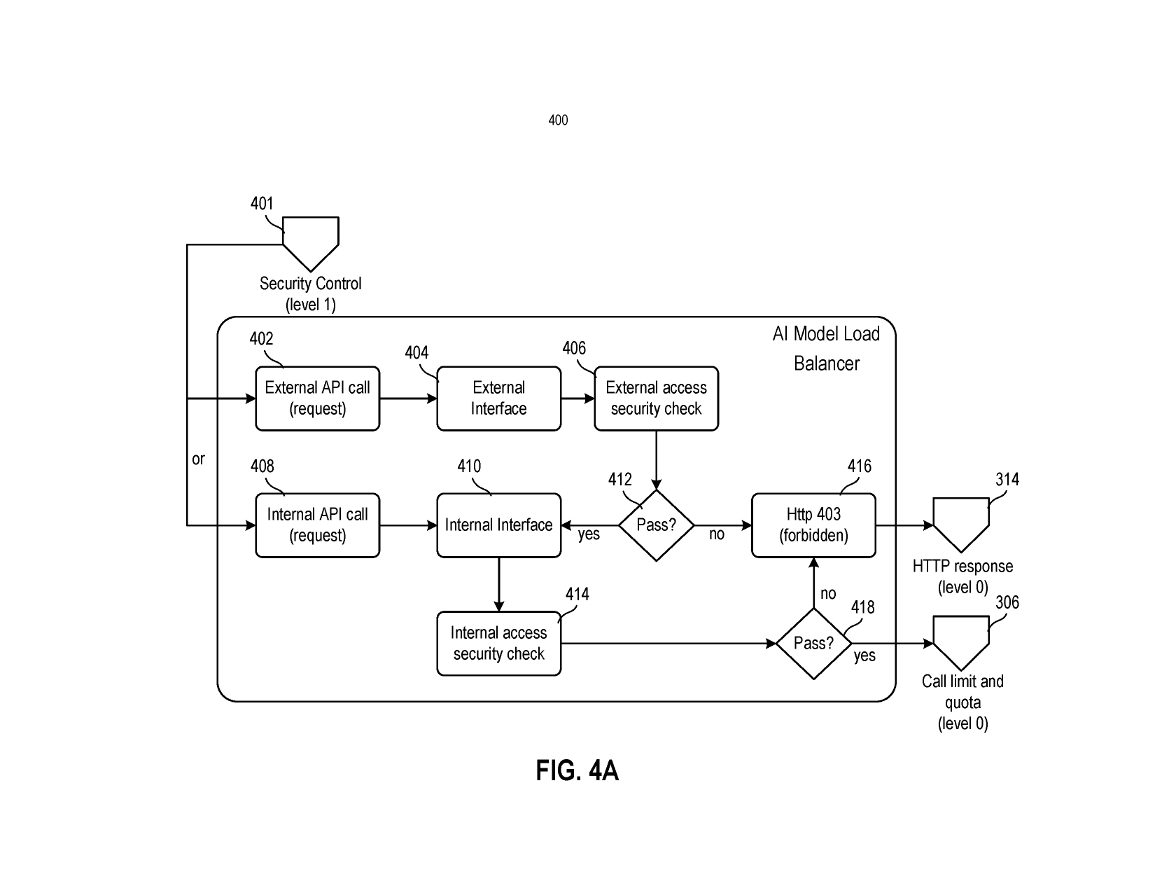

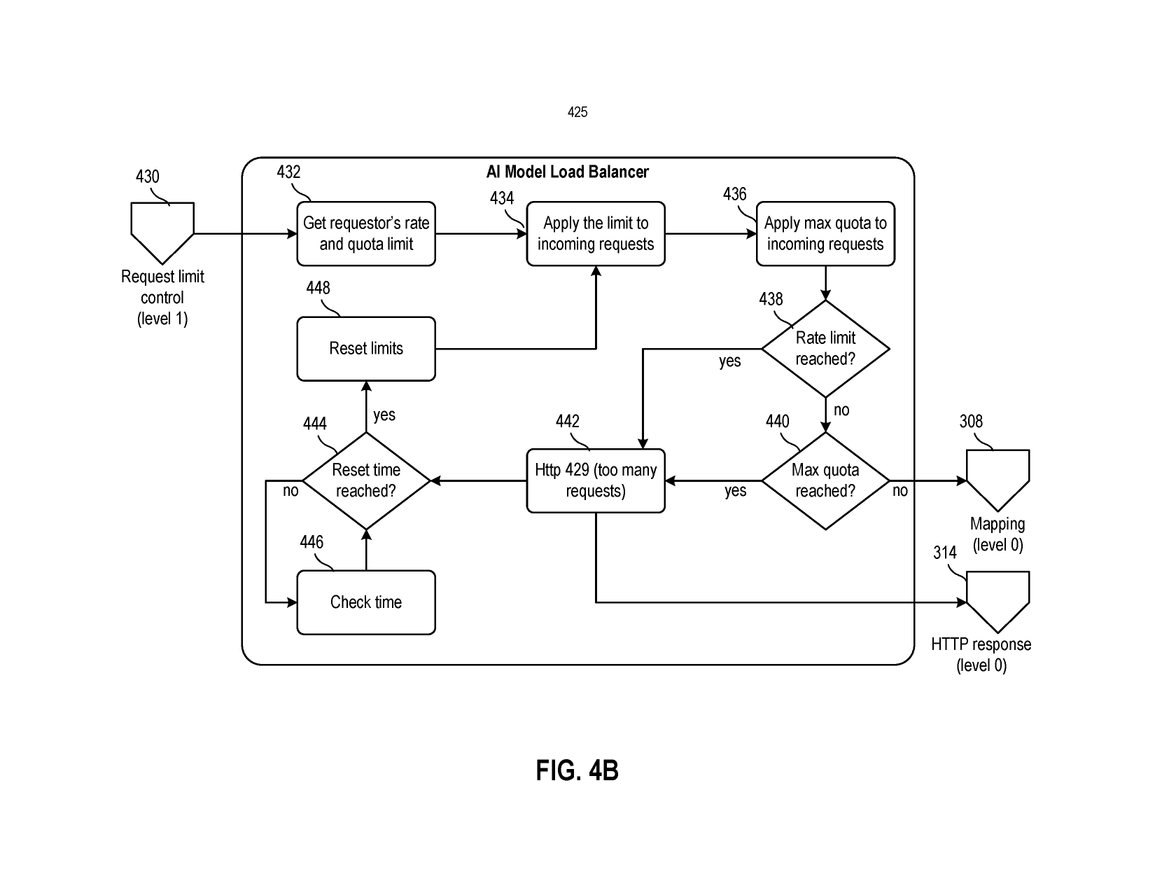

At step 304, the security control of the AI model load balancer can be implemented. The security control component can screen and validate the incoming requests. The AI model load balancer can apply different rules depending on the access type, such as verifying the requestor's IP address and key, and applying open web application security project (OWASP) rules to facilitate checking that the request is secure. This can allow for only authenticated and authorized requests to proceed further towards step 401 of FIG. 4A.

At step 306, the request limit and quota can be implemented by the AI model load balancer. The request limit control can include throttling the rate of calls and enforcing a maximum allowed daily quota for each requestor. The imposed limits can be individually configured for a group or project, which can allow for the system to handle requests efficiently without being overwhelmed. This step can check if the request meets the rate and quota limits by proceeding to step 430 of FIG. 4B.

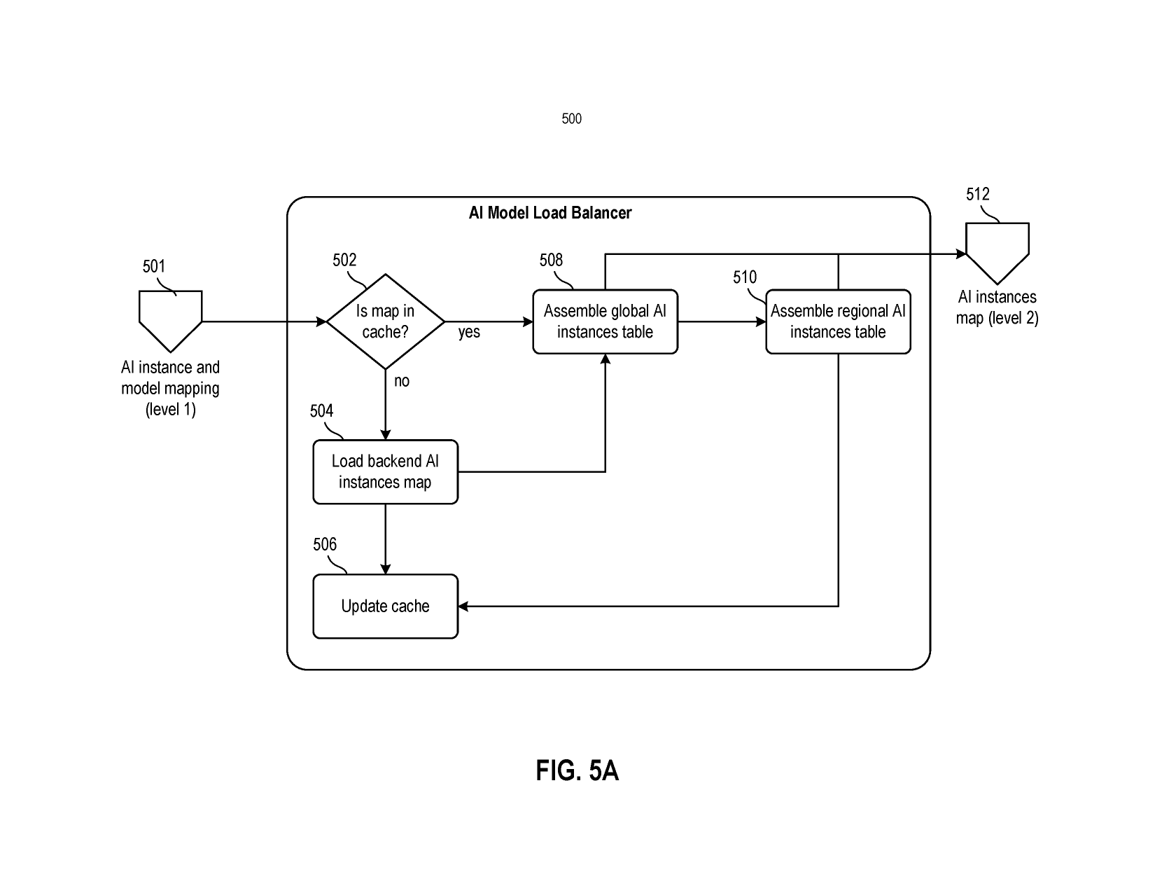

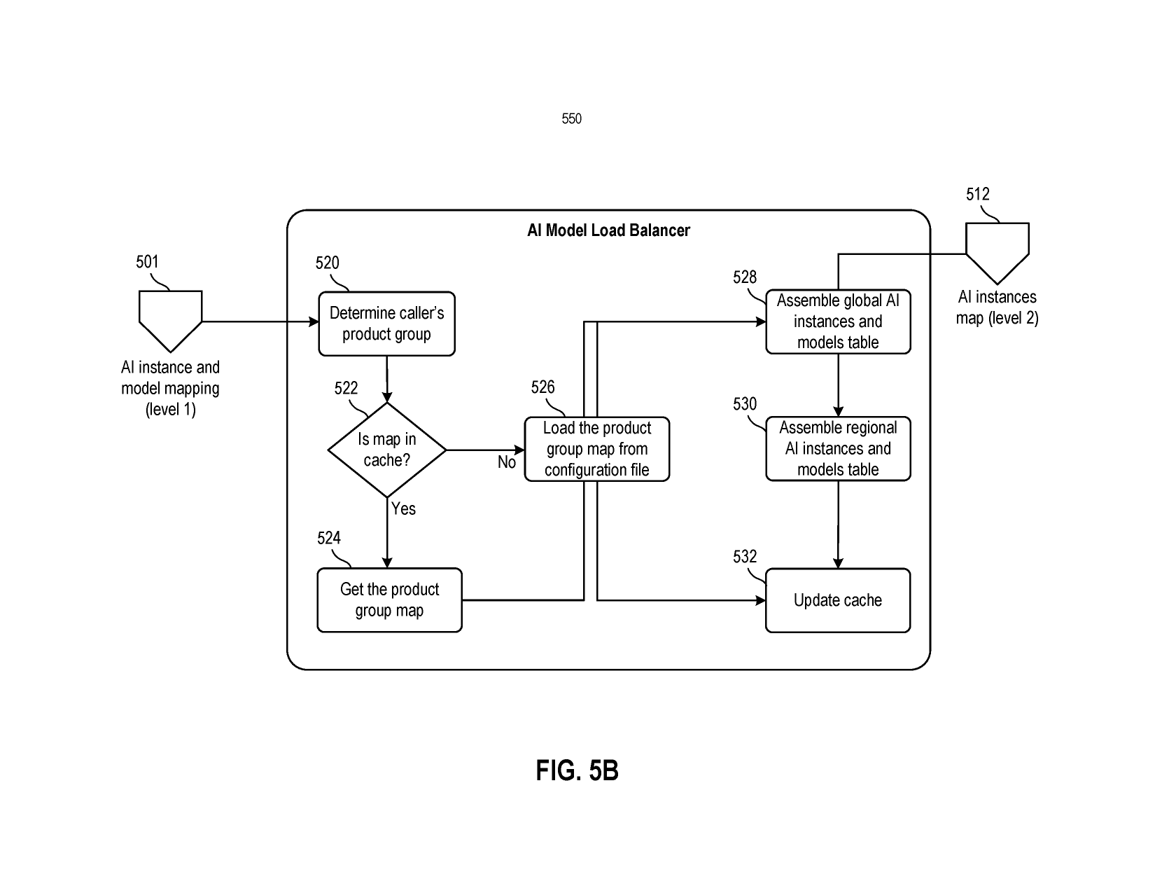

At step 308, the mapping of the AI instances can be implemented by the AI model load balancer. The AI instance and model mapping component (e.g., the instance selector) can load a preconfigured map into memory for dynamic load balancing and AI model location. This map can include information about the assigned AI instances and the regions in which various AI models are deployed. This can allow for the request to be mapped to an appropriate AI model instance based on the requestor's group or project. The appropriate AI model instance can include the geographically closest available and non-overburdened AI model instance that matches the parameters or characteristics indicated by the AI model request. The mapping process can proceed towards AI instance and model mapping via step 501 of FIG. 5A or FIG. 5B.

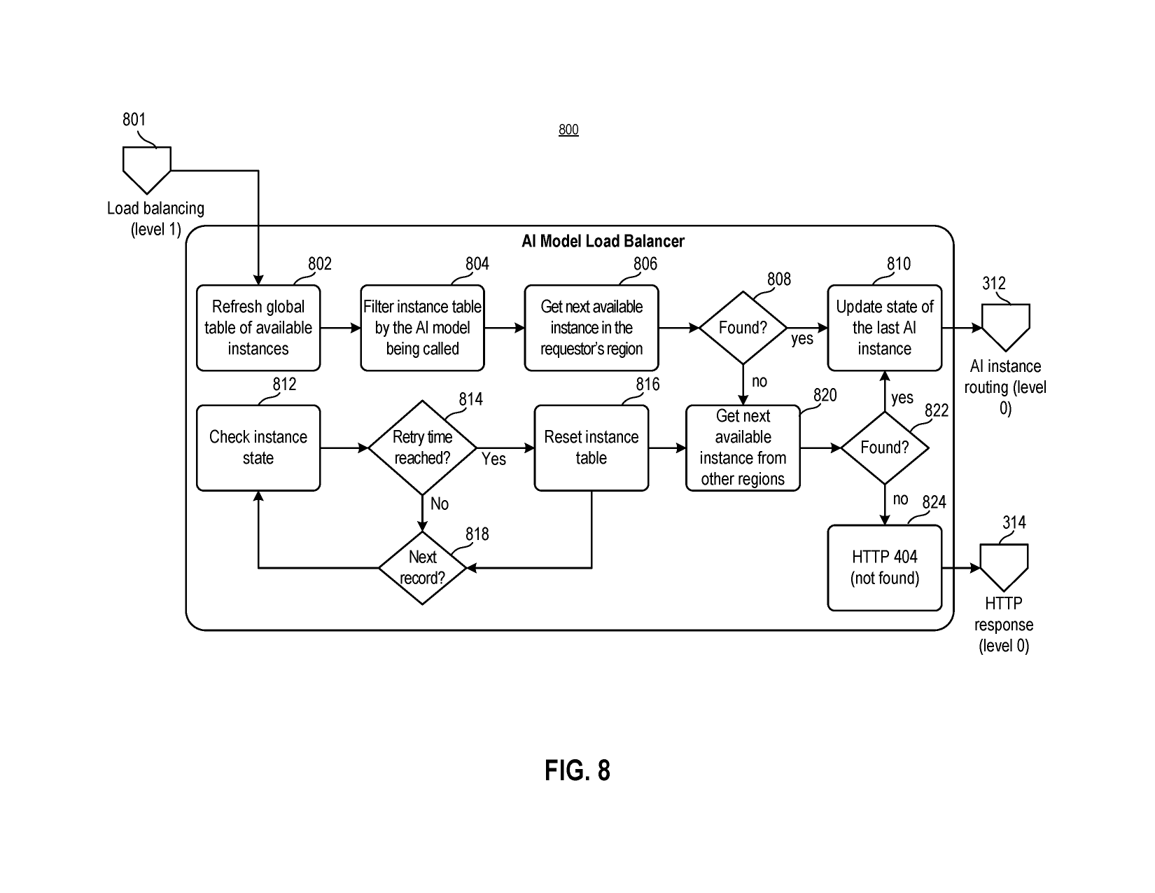

At step 310, the AI model load balancer can implement the load balancing of the request to the available or selected instance of the AI model. The AI model load balancer can spread incoming requests across regions, accounts, and AI models. The AI model load balancer can prioritize AI instances that are closest to the requestor's region, but if the region does not have the requested AI model, it locates available AI instances in other regions. This step can allow for the request to be routed to an AI instance that can service the request efficiently (e.g., by an AI model instance that is not overburdened and whose performance characteristics are within their respective acceptable or preferred thresholds). The method can proceed to the load balancing at step 801 of FIG. 8.

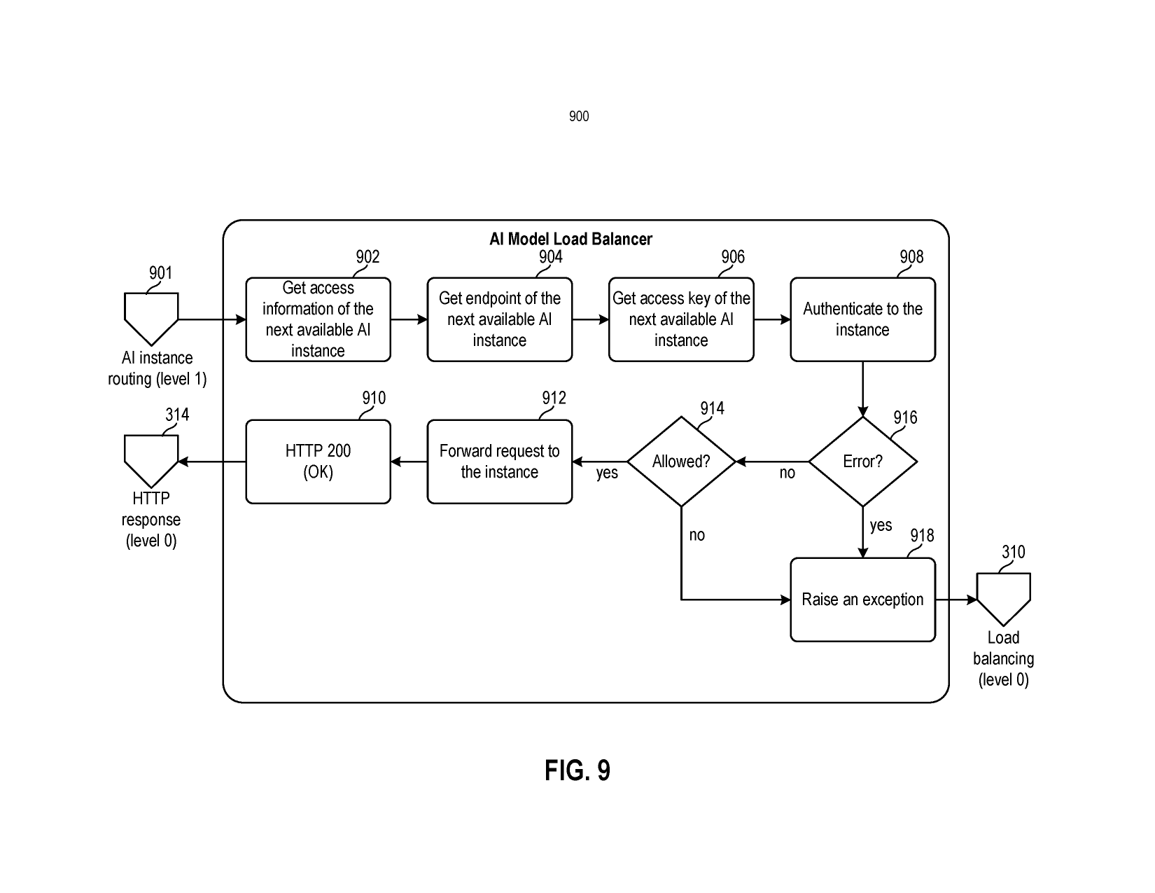

At 312, the method can include the AI model load balancer performing the forwarding of the request to the AI model instance. The AI model load balancer can include a routing component to route, send or forward the request to the identified AI model instance assigned by the load balancer. The method can route the request to the correct network where the AI instance is located and authenticate the request to the AI instance. This step can allow for the request to reach the appropriate AI model instance and receive a response by using or executing that AI model instance. The method can proceed to step 901 of AI instance routing at FIG. 9.

At 314, the method can include the AI model load balancer providing a response, such as executing an HTTP response. The AI model load balancer can formulate the HTTP response responsive to the AI model request as a response to the requesting client device. The HTTP response can include, for example, a response to a client device query that was handled by the AI models, including for example textual output to a request or a question.

FIG. 4A illustrates an example flow diagram of a method 400 for implementing security control and request validation in the AI model load balancing system. The method 400 can be integrated with other flow diagrams, such as method 300 of FIG. 3, to provide for a comprehensive AI model load balancing, request handling and routing. The method 400 can be implemented by one or more processors of a server, a cloud-based service, or any other service that includes an AI model load balancer.

At step 401, the method 400 can be initiated from a flow diagram of the method 300. The process can begin when a client device initiates an API call to request access to an AI model. This call can be received by the AI model load balancer, which can parse the incoming request to extract information about the requested AI model and the origin of the request.

At step 402, the external API call request is received. The API call can be an AI model request that can be flagged to undergo the external access security check. At step 404, the external interface can receive the API call (e.g., AI model request) and can initiate the security checks. At step 406, the external access security check can be performed. The AI model load balancer can validate the requestor's IP address and key, applying OWASP rules to check that the request is secure. In some implementations, if the request passes the security check, it can proceed to the next step at 412.

At step 412, the AI model load balancer can determine if the API call has passed the external access security check. If the response is in the negative (e.g., it did not pass) the AI model load balancer can at step 416 issue an HTTP 403 response marking the request as forbidden, further passing it to step 314 of the method 300 at FIG. 3 (e.g., for external response in the negative, barring the access). Alternatively, if at step 412 the determination is made that the security checks are passed, the method can progress towards internal interface as in step 410.

Alternatively, at step 408, the incoming API call can arrive from an internal system and can access the internal interface 410, potentially bypassing the external access security check at the step 406. At step 414, the method can perform internal access security steps in which the request authentication header and subscription keys can be validated and the request can be scoped down to the assigned API set of the group to which the requestor belongs. At 418 a determination can be made if the internal access security has passed. If the determination at step 418 is in the affirmative, the API call proceeds to step 306 of the method 300. Alternatively, if the determination is that the API call did not pass the internal access security check, then it is forwarded to the step 416 to issue the HTTP 403 (e.g., forbidden access) message, leading to step 314 of the method 300 of FIG. 3.

FIG. 4B illustrates an example flow diagram of a method 425 for implementing request limit control and quota management in the AI model load balancing system. The method 425 can be integrated with other flow diagrams, such as method 300 of FIG. 3 and method 400 of FIG. 4A, to provide a comprehensive request handling and routing. The method 425 can be implemented by one or more processors of a server, a cloud-based service, or any other service that includes an AI model load balancer.

At step 430, the method can initiate the set of determinations for ensuring that the rate at which the client device sending the request does not exceed the quota limit for the client device. The quota limit for the client device can be a threshold number of allowable number of requests that the client device is allowed to make within a time period. Similarly, the requestor’s rate can be a rate of requests that the client device is allowed to make, based on the account of the client.

At 432, the method 430 can retrieve the requester’s rate and quota limit. The AI model load balancer can access the preconfigured limits for the requestor's group or project. The requester’s rate and quota limits can allow for the client device to not overburden the system, and that the system can handle requests for all clients without being overwhelmed.

At step 434, the method can apply the rate limit to incoming requests. The AI model load balancer can monitor the client device’s requests and evaluate if they exceeded the limit. The AI model load balancer can throttle the rate of calls, ensuring that the requestor does not exceed the allowed number of requests per unit of time.

At step 436, the method can evaluate if the requesting client device has exceeded its maximum quota with the incoming request. The AI model load balancer can enforce a daily quota for each requestor, checking that the requestor does not exceed the allowed number of requests per day. This step can help manage the overall load on the system.

At step 438, the method can check if the rate limit has been reached. The AI model load balancer can determine if the requestor has exceeded the allowed number of requests per unit of time. If the rate limit has been reached (e.g., at 440) the method can proceed to steps 444 and 446. In some instances, the method can proceed to step 308 of FIG. 3.

At step 440, the method can check if the reset time has been reached. The AI model load balancer can determine if the time period for resetting the rate limit has elapsed. If the reset time has been reached (e.g., at 444), the method can proceed to step 442. Otherwise, it can proceed to step 444 to check time (e.g., in a loop). In some instances, the method can implement any order or combination of actions or operations 438 or 440. For instance, the method can apply or evaluate whether the incoming requests have reached or exceeded the respective thresholds corresponding to either the rate limit (e.g., operation 438) or the max quota (e.g., operation 440), or both the rate limit and the max quota.. In some implementations, if either one, or both, of these thresholds are met or exceeded, the method can proceed to next operations (e.g., 308 or 442).

At step 442, the method can determine that there are too many requests. The AI model load balancer can formulate an HTTP response indicating that the requestor has exceeded the allowed rate limit or daily quota. This response can include appropriate error codes and messages, informing the requestor to wait before making new requests. The method can proceed with an HTTP response at step 314 of FIG. 3. At step 448, the method can reset the limits and lead back to step 434 to apply the limit to incoming request.

FIG. 5A illustrates an example flow diagram of a method 500 for providing state maps for AI model instance load balancing. The method 500 can be integrated with other flow diagrams, such as method 300 of FIG. 3 and method 400 of FIG. 4A, to provide a comprehensive request handling and routing. The method 500 can be implemented by one or more processors of a server, a cloud-based service, or any other service that includes an AI model load balancer.

At step 501, the process can begin from the step 308 of the method 300 of FIG. 3, while mapping of the client request to state map of AI instances is being performed. At step 502, the load balancer can determine if the AI state map is in the cache. If the determination is in the affirmative and the map is found in the cache, the process may move towards step 508. Alternatively, the process may move toward step 504.

At step 504, the load balancer can load the backend AI instances map, such as a pre-configured shared map or a group or team specific map. The shared map can be used or an independent map which can be configured for a specific project. At 508, the load balancer can assemble the global AI instances table. The global AI instances table can be configured as the AI state map indicating all of the AI model instances across the regions and for all AI models provided. This table can be provided as AI instances map via step 512.

At 510, the load balancer can assemble regional AI instances table. The regional AI instances table can include an AI state map of a specific region. For example, each region can have its own AI model state map providing status or state of each AI model instance in the given region. From step 510, the assembled regional AI instances table can be used as input to update the cache at 506. At step 506, the AI instance and model mapping component can load a preconfigured map into memory for dynamic load balancing and AI model location. This map can include information about the assigned AI instances and the regions in which various AI models are deployed. This allows the request to be mapped to an appropriate AI model instance based on the requestor's group or project.

FIG. 5B illustrates an example flow diagram of a method 550 for providing state maps for AI model instance load balancing. The method 550 can be integrated with other flow diagrams, such as method 300 of FIG. 3 and method 400 of FIG. 4A, to provide a comprehensive request handling and routing. The method 550 can be implemented instead of method 500 of FIG. 5A, or vice versa. The method 550 can be implemented by one or more processors of a server, a cloud-based service, or any other service that includes an AI model load balancer.

At step 501, similar to method 500, the process can begin from the step 308 of the method 300 of FIG. 3, while mapping of the client request to state map of AI instances is being performed. The method 550 can then proceed to step or operation 520 to determine the caller’s product group. Determination of the caller’s product group can include the AI model load balancer of the server determining the location of the client device making a request based on which the AI model is to be used. The AI model load balancer can determine the region to which the client device belongs (e.g., the region within which the client device has sent the request or the closest region of the client device) and can identify the servers providing the requested AI models of the group.

At step 522, the load balancer can determine if the AI state map is in the cache. This step or operation can be implemented upon determining the caller’s (e.g., client device’s) product group. For instance, the method can determine in the affirmative (e.g., yes) that the AI state map for the product group is found in the cache, and responsive to this determination move towards the operation or step 524. Alternatively, if the determination is in the negative, the method can move toward step 526.

At step 524, the method 550 can get the product group map. For example, the method 550 can include the AI model load balancer issuing a request to acquire, access or get the product group map. The product group map can be an AI model map (e.g., AI model state or status map) for a particular region (e.g., the group of AI models of the region), for a plurality of regions or for all regions providing instances of various AI model types. The method can include getting or accessing the product group map from any source, such as a cache or any configuration file (e.g., such as at step 526).

At 526, the method 550 can include loading the product group map. In some configurations, the product group map can be loaded responsive to a request issued at 524. In some configurations, the product group map can be loaded from a cache. The product group map can be loaded from a configuration file. The configuration can be used to assemble a map or a table of AI model instances that are available in one or more (e.g., all) regions, including for example a global AI model instance map.

At 528, the method 550 can assemble global AI instances and models table. For instance, responsive to loading the product group map either from a configuration table or a cache (e.g., or both), the AI model load balancer can assemble a table of AI model instances for various AI models types across all available regions. The table can provide a mapping of AI model instances of each and every type of AI model that is available in each one of the regions. At this point, the method can provide the output table of AI instances and models to AI instances map at step 512.

At 530, the method 550 can assemble one or more regional AI instances and models tables. For instance, the AI model load balancer can generate or assemble a table of AI instances and AI model types of a particular region. The AI model load balancer can generate individual AI model maps for a plurality of regions. Each AI model map can include a table of AI instances and AI model types deployed and available in each of the regions.

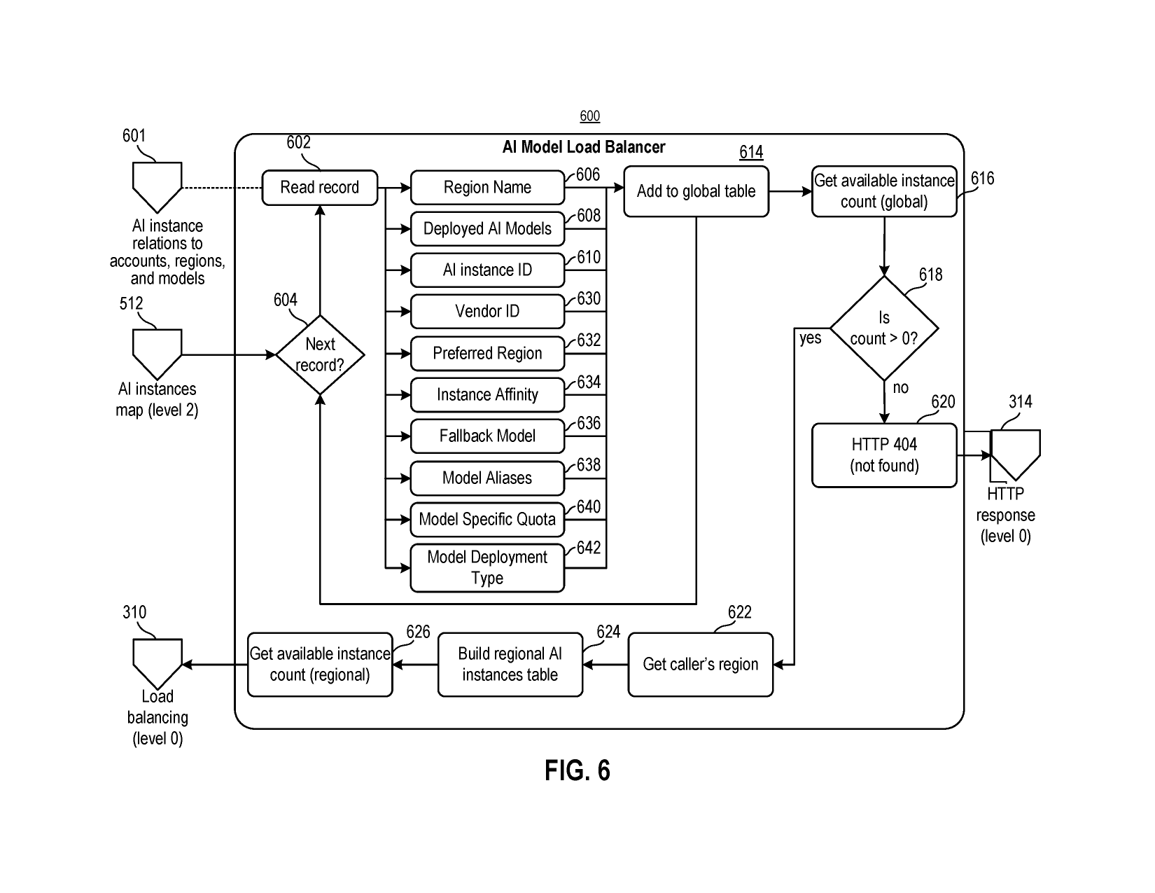

At 532, the method 550 can update the cache. The cache can be updated based on the product group map that is loaded from a configuration file (e.g., at step 526). The cache can be updated responsive to assembling a table of a regional AI instances and AI models (e.g., at step 530). The cache can be updated responsive to assembling a table of global AI instances and models across a plurality of regions (e.g., at step 528). FIG. 6 illustrates an example flow diagram of a method for managing AI instance relations to accounts, regions, and models. The method can be implemented using any system examples, such as systems described in FIGS. 1A- 2 or system 1000 of FIG. 10. The method can be implemented by a server, a cloud-based service, or any other service implementing AI model load balancer.

At step 601, the process can begin with the AI model load balancer accessing relations to accounts, regions and models. This can be performed, for example, while accessing or assembling a global AI instances table. At step 602, the AI model load balancer can read the record, such as by checking if the map is in cache. At step 604, the AI model load balancer can update the cache with the latest information about AI instances and their availability, such as from the next record.

At steps 606-612, the AI model load balancer can read data on various aspects of a record. The record can include various data portions or fields that can be used for load balancing, including for example region name or identifier, information on deployed AI models, identifiers of AI model instances, identifiers of various vendors (e.g., model providers), information on preferred region to utilize for AI model services, information on preferred instances or instance affinity, information on fallback AI models to utilize, information on model aliases, information on model specific quotas or model deployment types. For example, at 606, the AI model load balancer can access or read data on a region name. At step 608, the AI model load balancer can read data on deployed AI models. At 610, the load balancer can read data on AI instance identifiers. At 630, the load balancer can access or read a vendor identifier. At 632, the load balancer can access or read information on preferred region (e.g., identifier of a preferred region for provide AI service). At 634, the load balancer can access or read an information on instance affinity (e.g., a preferred AI instance to utilize for an AI model type). At 636, the load balancer can access or read an information on a fallback model (e.g., an AI model to utilize if a primary or desired AI model is unavailable). At 638, the load balancer can access or read an information on one or more model aliases (e.g., an alias of one or more AI models in a region). At 640, the load balancer can access or read an information on a model specific quota (e.g., a threshold value for a quota for an AI model), such as a max quota of step 440 or a rate limit of 438 at FIG. 4B. At 642, the load balancer can access or read an information on a model deployment type, such as an identifier of an AI model type. The load balancer can utilize any data read or accessed in acts 606-610 and 630-642, including any other information or metadata on AI models and their AI instances (e.g., availability, number of requests per time period or other information) to make determinations or selections of AI models or AI model instances to utilize.

At 614, the method can add the read data to the global table, such as a table included within or used to generate the AI model map. For example, the AI load balancer can add to the global table (e.g., AI model map for a plurality of regions) any combination of information or data read or accessed at steps or operations 606-610 and 630-642. The read or accessed information can be used to populate or generate the global table of AI instances and models.

At 616, the method can get the available instance count (e.g., the global count of the AI model instances of the same AI model type across the regions). At 618, the method can determine if the count is greater than 0. If the determination is in the affirmative, the process may continue towards step 622. Otherwise, if the determination is negative (e.g., the count is not greater than 0), the process can lead to step 620 to issue an HTTP 404 (not found) response, such as via an HTTP response of step 314 of FIG. 3.

At 624, the method can build regional AI instances table. The regional AI instances table can include the statuses of all AI instances of the AI models at a given region. At 626, from the Ai instances tables, the method can get the count of the available AI instances. This count can be used for load balancing and determining if the request is to be forwarded to the give AI model instance. From the step 626, the method can proceed towards load balancing at 310 of FIG. 3.

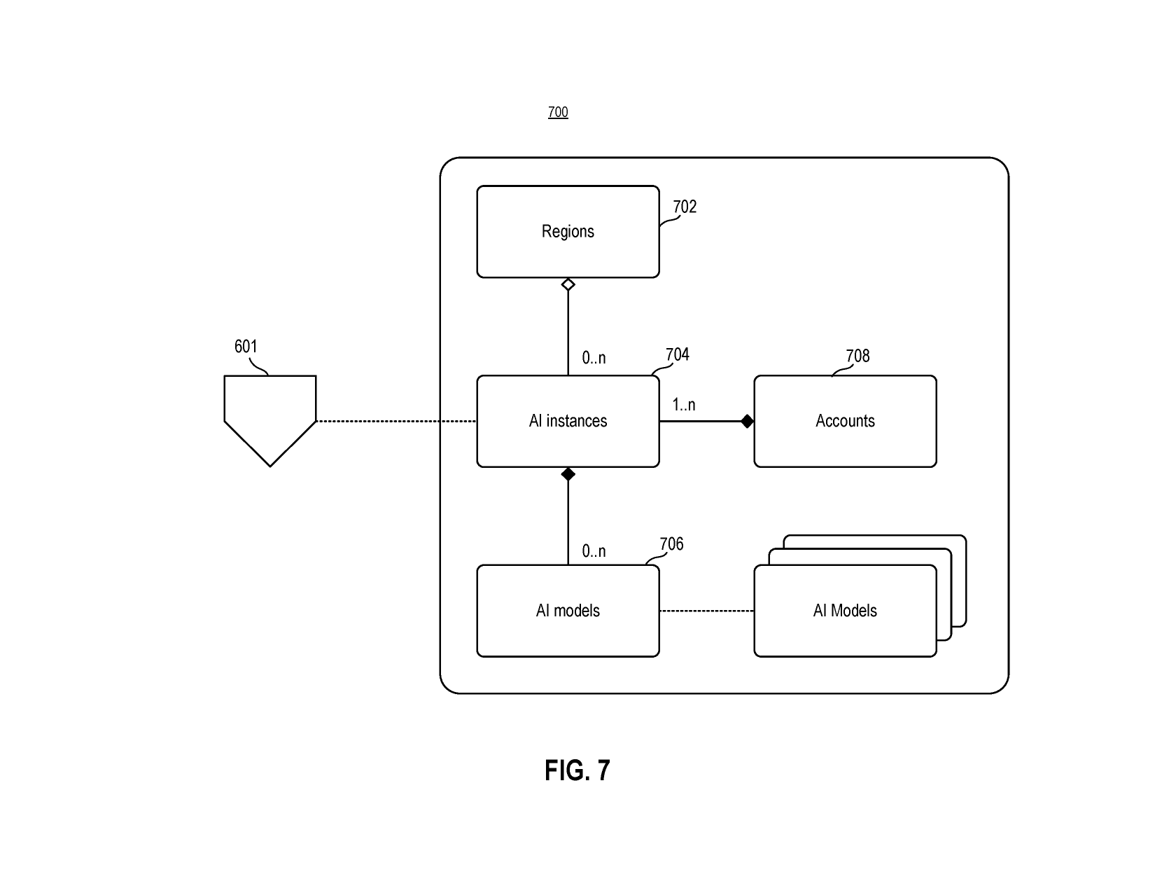

FIG. 7 illustrates an example method 700 of providing compositions and relations of AI instances in an AI model load balancer. At step 701, the method 700 can be initiated by reading in the data from a global AI instances table as in FIG. 6. Such data can include information about AI instances deployed across various regions and their availability.

At step 702, the AI model load balancer can access, utilize or check the data on the regions. At 704, the AI model load balancer can access, utilize or check the data on the AI instances. At 706, the AI model load balancer can access, utilize or check the data on AI model instances (e.g., from the plurality of AI model types available). At 708, the AI model load balancer can access utilize or check the data on accounts associated with the client devices or users making the AI model requests (e.g., for authentication or access). The accounts can be associated with deployed AI instances, such as cloud provider’s accounts with a threshold or a cap on the maximum total quota allowed for one or more AI instances within an account or a region.

FIG. 8 illustrates an example flow diagram of a method 800 for managing and updating maps for AI model instance load balancing. The method can be implemented using any system examples, such as systems described in FIGS. 1A-2 or system of FIG. 10. The method can be implemented by a server, a cloud-based service, or any other service implementing AI model load balancer.

The method 800 of load balancing AI model instances in an AI model load balancer begins at step 801, which can be initiated during the course of performance of step 310 of method 300 of FIG. 3. From step 801, the method 800 can lead to step 802, where the AI model load balancer can refresh the AI model map, including its global table of available instances.

At step 804, the AI model load balancer can filter instance table by the AI model being called. At 806, the AI model load balancer can get the next available instance in the requestor’s region. At 808, the load balancer can determine if the next available instance in the requestors region is found. If the answer is in the affirmative, the method can continue on to step 810. Otherwise, the method can proceed with step 820.

At 812, the AI method load balancer can check the state of the AI model instance. The state can be any state, such as that the AI model instance is active, inactive, operational, faulty (e.g., detected an error), being used or accessed by a set number of client devices, being overburdened (e.g., receiving more requests per unit of time than the limit threshold for the AI model instance), or not being overburdened.

At 814, the method can include retrying if the time is reached. At 816, the method can reset the instance table. At 818, the load balancer can check for the next record. At 822, the AI model load balancer can determine if the get next available instance from other regions is found. If the answer is in the affirmative, the method can update the state of the last AI instance and proceed to AI instance routing at steps 312 of FIG. 3. Otherwise, the method can proceed, via step 824, to HTTP 404 message towards HTTP response at step 314 of the FIG. 3.

FIG. 9 illustrates an example flow diagram of a method 900 for AI instance routing in an AI model load balancing system. The method can be implemented using any system examples, such as systems described in FIGS. 1A-2. The method can be implemented by a server, a cloud-based service, or any other service implementing AI model load balancer.

The method 900 can initiate at step 901 at the AI instance routing, which can begin during the course of performing step 312 of method 300 at FIG. 3. Step 901 can lead to step 902, where the can get access information of the next available AI model instance. At 904, the load balancer can get endpoint of the next available AI instance. At 906, the method can get access to key of the next available AI instance. At 908, the method can authenticate to the AI instance.

At step 916, the method can determine if there was an error in the authentication. If the answer is in the affirmative, the method can proceed to step 918 to raise an exception and move towards step 310 of FIG. 3. Otherwise, the method can proceed to step 914 where the determination can be made if the AI model instance is allowed. If the answer is in the affirmative, at step 912 the method can forward the request to the AI model instance. Otherwise, the method can proceed to step 918 to raise the exception and proceed to step 310 of FIG. 3.

At step 910, upon forwarding the request to the AI instance at step 912, the method can generate an HTTP response, which can be an HTTP 200 response (e.g., OK), leading to the step 314 of the method 300 to provide the HTTP response to the AI model request.

FIG. 10 illustrates an example client application 1000 for using AI model instance load balancing, according to an embodiment. The system 100 can allow users on client devices 102 operating their local client applications 238 to interact with the remaining components of the system 1000. Client devices 102 can utilize a directory 1001. The client devices 102 can access the front end applications 1008 via a traffic manager 1002, an application gateway 1004, and a firewall 1006. The application gateway 1004 can allow the client devices 102 to access (e.g., via their client applications 238) various AI API 1010 applications via a virtual network 1012 (e.g., an example of network 104). The AI API 1010 can allow users to interact with various AI services, such as natural language processing, image recognition, and predictive analytics. These services can be used to analyze data, generate insights, and automate tasks based on user inputs.

A continuous integration and continuous deployment (CI/CD) pipeline 1014 can be coupled with the front end applications 1008 and applications 1016 to facilitate continuous integration and continuous deployment of AI models 234. The CI/CD pipeline 1014 can automate aspects of the process of building, testing, and deploying AI models that can be updated and delivered over time, potentially creating discrepancies across the types of AI models being provided. Accordingly, as AI models can be updated at any time or rates, the AI model requests can be processed to identify characteristics or performance indications indicative of the specific type of AI model that should be used (e.g., including any variations in model revisions) to check that the client device receives services from the instance of a desired AI model type.

The applications 1016 can be coupled with the AI API 1010 to access the AI models 234. The AI models 234 can include various types of AI models, such as supervised learning models for classification and regression tasks, unsupervised learning models for clustering and association tasks, reinforcement learning models for decision-making tasks, and transformer models for natural language processing.

An AI framework 1020 can be connected via a private endpoint 1018 to provide various functionalities to the applications 1016, such as model training, evaluation, and deployment. This framework can support the development and management of AI models, allowing creation and refinement of AI models based on specific design goals.

The applications 1016 can be connected to a database 1022, which can store data used by the AI models and applications. This database can include structured and unstructured data, providing a repository for information that can be accessed and analyzed by the AI models, such as AI model training data sets.

A monitoring function 1024 can allow the system to track the performance and health of the applications and AI models. This function can provide real-time insights into system metrics, such as response times, error rates, and resource utilization, enabling proactive management and optimization of the system. Integrated services 1026 can provide various functionalities to the system, such as security management, data encryption, and compliance monitoring. These services can check that the system operates securely and adheres to relevant regulations and standards or protect user data.

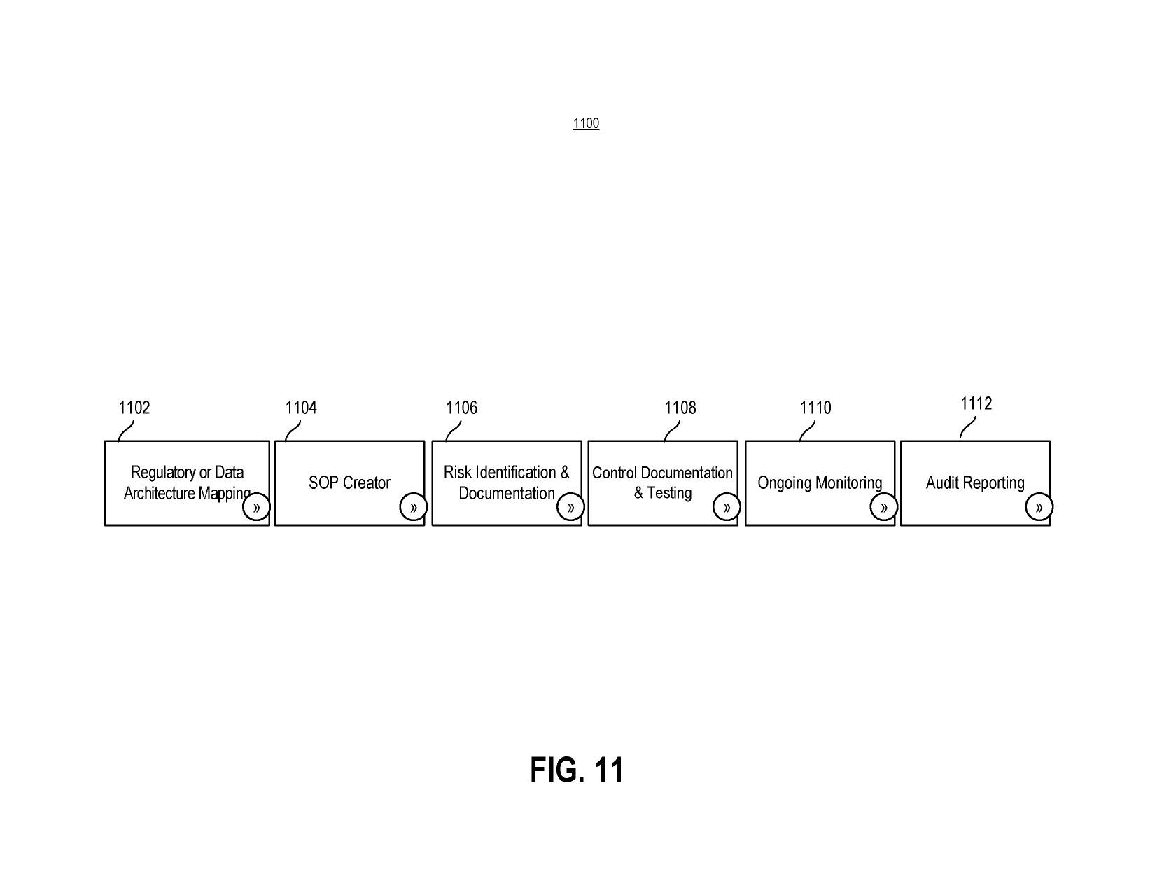

FIG. 11 illustrates an example method 1100 for utilizing AI model load balancing in a course of an automated process. The example method 1100 can include a flow diagram of steps for transforming a process, risk, control, digital, and audit lifecycle. The method 1100 can be integrated with other flow diagrams, such as methods 300, 400, 425, 500, 600, 700, 800 and 900 and utilize functionalities of system 1000, to provide a comprehensive set of operations. The method 1100 can be implemented by one or more processors of a server, a cloud-based service, or any other service described herein, which can be incorporated into an AI model load balancer.

At step 1102, the method 1100 can perform cross mapping of regulatory data across regional jurisdictions or mapping datasets across different governance, risk, and compliance (GRC) systems. This can be implemented with respect to any combination of requirements or datasets to determine similarities and applicability. The method can perform cross mapping of regulatory requirements across regional jurisdictions or mapping datasets across different GRC systems. AI model load balancer can be called (e.g., via API) to perform any of the tasks or operations associated with this step.

At step 1104, the method 1100 can create standard operating procedures (SOPs) based on a video and audio recording of a process or activity walkthrough. The method utilize prior recordings of tasks to develop or infer a process for documentation or control processing. The method can use the video and audio recordings of a process or activity walkthrough to infer the steps or tasks of the process. AI model load balancer can be called (e.g., via API) to perform any of the tasks or operations associated with this step.

At step 1106, the method 1100 can categorize risks within the provided taxonomy and update risk descriptions to fit to a predetermined standard. The method can utilize risk identification when reviewing applicability for risk categorization or after changes to risk taxonomy. As the risks can be identified at step 1106, at this step the method can categorize the identified risks in the context of the provided taxonomy and update risk descriptions to fit the standard. This process can accelerate how quickly risks are reviewed and categorized. AI model load balancer can be called (e.g., via API) to perform any of the tasks or operations associated with this step.

At step 1108, the method can uplift control descriptions and generate insights on the control inventories. This step is applicable for performing initial assessment of control documentation to allow for alignment to standard and prepare for control design testing. This step can be used to uplift control descriptions and generate insights on the control inventories. The method can perform initial assessment of control documentation to allow for alignment to standard and prepare for control design testing. AI model load balancer can be called (e.g., via API) to perform any of the tasks or operations associated with this step.

At step 1110, the method 1100 can extract information from contracts, invoices, leases, and other documents for clients. When collecting data to develop datasets from PDFs or semi-structured data, the method can aggregate information for control testing or documentation review. The method can extract information from contracts, invoices, leases, and other documents for clients. When seeking to collect and develop datasets from PDFs or semi-structured data, the method can aggregate information for control testing or documentation review. AI model load balancer can be called (e.g., via API) to perform any of the tasks or operations associated with this step.

At step 1112, the method can dynamically create audit reports with a scoping memo, work program, observation logs, and Service Organization Control (SOC) reporting templates using elements from SOC reports. The method can leverage available documentation as inputs to accelerate the creation of audit reports. For instance, the method can dynamically create audit reports with a scoping memo, work program, observation logs, and SOC reporting templates using elements from SOC reports, leveraging available documentation as inputs to accelerate the creation of audit reports. AI model load balancer can be called (e.g., via API) to perform any of the tasks or operations associated with this step.

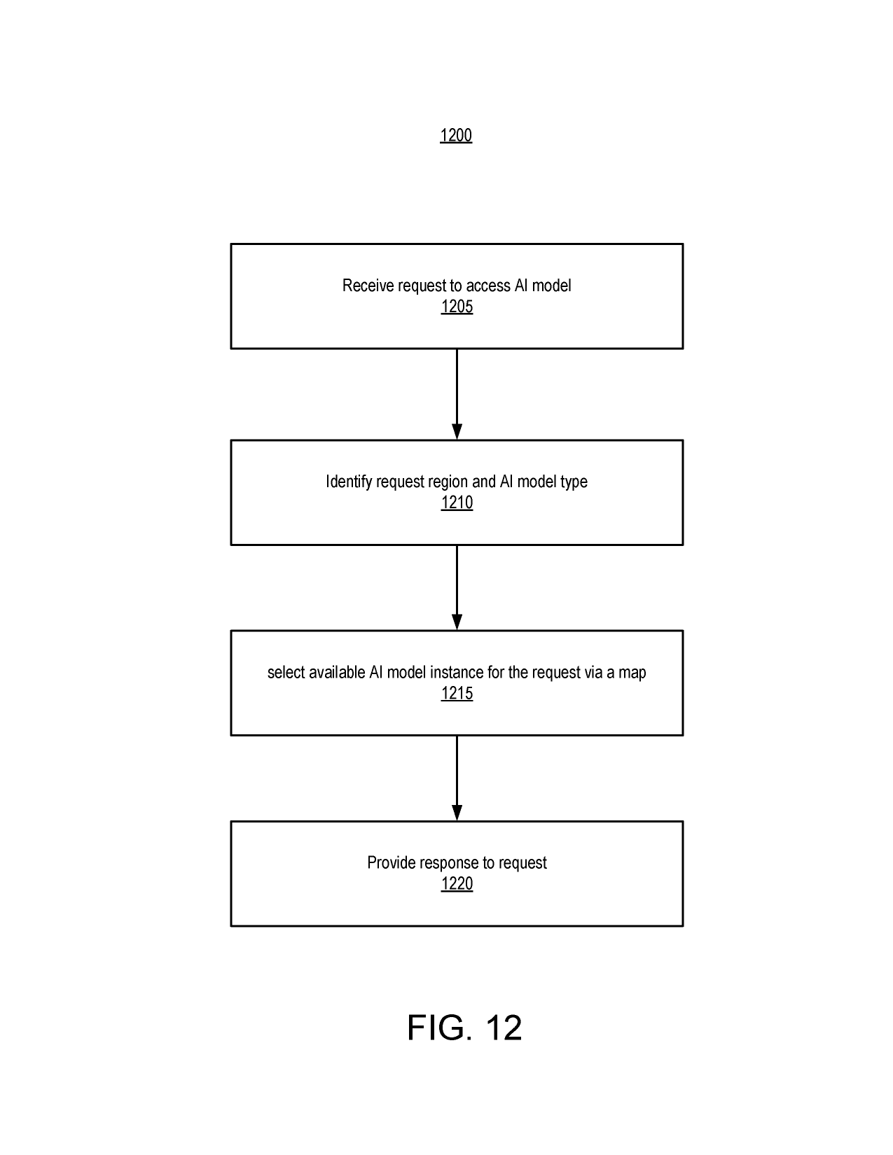

FIG. 12 illustrates an example method 1200 for providing a state map based AI model instance load balancing. T he method 1100 can be integrated with other flow diagrams, such as methods 300, 400, 425, 500, 600, 700, 800 and 900 and utilize functionalities of system examples 200 or 1000, or any other system functionalities, to implement its operations. The method 1200 can be implemented by one or more processors of a server, a cloud-based service, or any other service described herein, which can be incorporated into an AI model load balancer. The method 1200 can include steps 1205-1220. At 1205, the method can receive a request to access an AI model. At 1210, the method can identify a request region and an AI model type. At 1215, the method can select an available AI model instance for the request using a map. At 1220, the method can provide the response to the request.

At 1205, the method can receive a request to access an AI model. The method can include one or more servers executing an AI model load balancer receiving a request. The request can be received from a client device in a region to access an instance of a type of artificial intelligence (AI) model from a plurality of AI models deployed across a plurality of regions. The one or more servers can maintain one or more AI model maps. The AI model maps can provide information on or indicate each instance of an AI model of the plurality of AI models in each region of the plurality of regions based at least on the type of AI model. An AI model map can represent the current state of operation of each of the AI model instances in one or more regions, such as the AI model instance’s availability, rate of load (e.g., number of requests serviced per unit of time) and geolocation or region of the AI model instance.

The method can include the one or more processors of the one or more servers validating the incoming request. The request can be validated using one or more security control policies. The request can be authenticated and the access to the AI models can be granted using information associated with an electronic account associated with the client device. The method can include receiving information on status of a plurality of instances of a plurality of AI models. The information received can be information included in or associated with the one or more AI model maps. The plurality of instances can include an AI model instance in the same or a different region as the incoming request. The method can include updating the one or more AI model maps using the information or based on the status of the instances of the AI models in the plurality of regions.

At 1210, the method can identify a request region and an AI model type. The method can include the one or more processors of the one or more servers identifying the region of the request and the type of the AI model requested. The method can include the AI model load balancer parsing the request and identifying various characteristics or performance data or parameters for the AI model being requested or indicated by the information in the request. The method can utilize at least a portion of the request to identify the region of the client device that sent the request. The method can utilize at least a portion of the request to identify the type (e.g., the revision, performance characteristics or functional features) of the AI model to be used for processing the request.

The method can include the AI model load balancer detecting a geolocation from which the request is originated and identifying the region of the request based on the geolocation. The method can include determining a match between the region of the instance of the type of AI model and the region of the request. The method can include determining, using the AI map, to provide access to the instance of the type of AI model based on the match. The match can be determined based on a match between the operational parameters or characteristics of the AI model type inferred or determined from the portion of the incoming AI model request.

The method can include the AI model load balancer determining whether the request meets one of a rate of calls for the region and a threshold for number of calls for the region per time period. For example, the AI model load balancer can determine that the request meets the one of the rate of calls for the region and the threshold for the number of calls for the region per time. The AI model load balancer can provide access to the instance of the type of AI model deployed in the region based on the determining that the request meets the one of the rate of calls for the region and the threshold for the number of calls for the region per time. For instance, responsive to this determination, the AI model request received from the client device can be provided as input to an instance of the determined or selected AI model type to process the request.

The method can include the AI model load balancer determining whether the request meets one of a rate of calls for the region and a threshold for number of calls for the region per time period. The AI model load balancer can determine to deny or to not provide access to the AI model instance in the same region as the region from which the client device that generated the request. Instead, the AI model load balancer can determine to select, prioritize or provide access to a second instance of the same type of AI model in a second region of the plurality of regions responsive to determining that the request does not meet the one of the rate of the calls for the region and the threshold for the number of calls for the region per time. For instance, the AI model load balancer can determine that the matching instance of AI model type suitable to service the request is overburdened (e.g., receives a number of requests that is greater than threshold). In response to the AI model instance being overburdened, the AI model load balancer can identify a different AI model instance in the same or a different region to provide the service to the request.

At 1215, the method can select an available AI model instance for the request using a map. The method can include the one or more servers using the AI model map to determine the instance of the type of the AI model deployed in the region. The AI model load balancer can utilize one or more AI model maps to identify or select the particular instance of the AI model type from the plurality of AI models deployed in the one or more regions. The AI model load balancer can utilize regional AI model maps to identify the most suitable (e.g., most closely matching parameters or characteristics) of the AI model type to the AI model request within a single region. The AI model load balancer can utilize one or more AI model maps indicating statuses and availabilities of all AI model instances of all AI model types across all the regions.

The AI model load balancer can identify, based on the request, one or more specifications for one or more AI models of the plurality of AI models. The AI model load balancer can identify, based on the one or more specifications, the type of AI model requested. The AI model load balancer can use the AI model map to identify one or more regions of the plurality of regions that provide the instance of the type of AI model. The method can include the AI model load balancer selecting, from the one or more regions, a region of the instance of the type of AI model to generate the response based on the region from which the request was originated. For example, the region of the instance of the type of AI model can be selected based at least on a proximity between the region of the request (e.g., region in which the request was originated) and the region of the instance of the type of AI model.

The method can include prioritizing the instance of the type of AI model based on a proximity of the region of the request to a region in which the instance of the type of AI model is provided. For instance, the AI model load balancer can prioritize or prefer a first AI model instance of a selected AI model type from a first region over a second AI model instance of the selected AI model type in a second region based on the first region being geographically closer (e.g., having a shorter geographical distance) to the region of the request than the second region (e.g., which may be further away from the request region).

The method can include monitoring performance metrics of the plurality of AI models. The AI model load balancer can adjust the one or more AI model maps according to the performance metrics. The performance metrics can include any one or more of: response time, accuracy rate, processing speed, resource utilization, error rate, throughput, latency, availability, scalability, and reliability. The AI load balancer can determine, using the one or more AI models map, the instance of AI model responsive to requests, based on the performance metrics. For example, the AI model load balancer can adjust the one or more AI model maps according to the performance metrics. The AI load balancer can determine, using the one or more AI models map, the instance of AI model responsive to requests, based on the performance metric.

The method can include determining a number of instances of the type of AI model provided in the plurality of regions. The AI model load balancer can determine a number of requests for the number of instances of the type of AI model. The AI model load balancer can scale the number of instances of the type of AI model based on the number of requests. For example, if the AI model load balancer detects an increase in requests for a specific AI model in a particular region, the method can dynamically allocate additional instances of that AI model to meet the demand. For instance, if the number of requests decreases, the AI model load balancer can reduce the number of instances to adjust the resource utilization.

At 1220, the method can provide the response to the request. The method can include the one or more servers providing a response to the request based on the determination or selection of the AI model instance. The AI model load balancer can provide the response indicating that the access to an instance of the AI model is granted. The response can include an output (e.g., text or content) generated by the selected AI model instance based on the portion of the AI model request input into the selected instance of the type of AI model.

The method can continue to adjust the AI model map based on real-time performance metrics and usage patterns. The method can monitor performance metrics such as response time, accuracy rate, processing speed, resource utilization, error rate and throughput. The AI model load balancer can make selections of the AI model instances based on these parameters. For example, if the system detects that certain AI model instances are performing within acceptable thresholds and handling requests efficiently, it can prioritize such an AI model instance for future requests. For instance, if an AI model instance is experiencing high error rates (e.g., error rates exceeding a threshold) or slow response times, the system can reallocate resources to other AI model instances that are available in order to maintain high performance and user satisfaction.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A system comprising:
a server comprising one or more processors to:
receive a request from a device in a region to access an instance of a type of artificial intelligence (AI) model from a plurality of AI models deployed across a plurality of regions, the server maintaining an AI model map of each instance of an AI model of the plurality of AI models in each region of the plurality of regions based at least on the type of AI model;
identify, based at least on the request, the region of the request and the type of AI model requested;
determine, using the AI model map, the instance of the type of AI model deployed in the region from the plurality of AI models deployed in the region;
provide, based at least on the determination, a response to the request providing access to the instance of the type of AI model.

2. The system of claim 1, further comprising the one or more processors to:
determine whether the request meets one of a rate of calls for the region and a threshold for number of calls for the region per time period; and
provide access to the instance of the type of AI model deployed in the region based on the determining that the request meets the one of the rate of calls for the region and the threshold for the number of calls for the region per time.

3. The system of claim 1, further comprising the one or more processors to:
determine whether the request meets one of a rate of calls for the region and a threshold for number of calls for the region per time period; and
determine to provide access to a second instance of the type of AI model in a second region of the plurality of regions responsive to determining that the request does not meet the one of the rate of the calls for the region and the threshold for the number of calls for the region per time.

4. The system of claim 1, further comprising the one or more processors to:
identify, based on the request, one or more specifications for one or more AI models of the plurality of AI models; and
identify, based on the one or more specifications, the type of AI model requested.

5. The system of claim 4, further comprising the one or more processors to:
identify, using the AI model map, one or more regions of the plurality of regions that provide the instance of the type of AI model; and
select, based on the region of the request, from the one or more regions, a region of the instance of the type of AI model to generate the response.

6. The system of claim 5, wherein the region of the instance of the type of AI model is selected based at least on a proximity between the region of the request and the region of the instance of the type of AI model.

7. The system of claim 1, further comprising the one or more processors to:
detect a geolocation from which the request is originated; and
identify the region of the request based on the geolocation.

8. The system of claim 1, further comprising the one or more processors to:
determine a match between a region of the instance of the type of AI model and the region of the request; and
determine, using the AI map, to provide access to the instance of the type of AI model based on the match.

9. The system of claim 1, further comprising the one or more processors to validate, using one or more security control policies, the request.

10. The system of claim 1, further comprising the one or more processors to:
receive information on status of a plurality of instances of a plurality of AI models, the plurality of instances comprising the instance; and
update, responsive to the information, the AI model map based on the status of the instances of the AI models in the plurality of regions.

11. The system of claim 1, further comprising the one or more processors to prioritize the instance of the type of AI model based on a proximity of the region of the request to a region in which the instance of the type of AI model is provided.

12. The system of claim 1, further comprising the one or more processors to:
monitor performance metrics of the plurality of AI models;
adjust the AI model map according to the performance metrics; and
determine, using the AI models map, the instance of AI model based on the performance metrics.

13. The system of claim 1, further comprising the one or more processors to:
determine a number of instances of the type of AI model provided in the plurality of regions;
determine a number of requests for the number of instances of the type of AI model; and
scale the number of instances of the type of AI model based on the number of requests.

14. A method comprising:
receiving, by one or more servers, a request from a device in a region to access an instance of a type of artificial intelligence (AI) model from a plurality of AI models deployed across a plurality of regions, the one or more servers maintaining an AI model map of each instance of an AI model of the plurality of AI models in each region of the plurality of regions based at least on the type of AI model;
identifying, by the one or more servers based at least on the request, the region of the request and the type of AI model requested;
determining, by the one or more servers using the AI model map, the instance of the type of AI model deployed in the region from the plurality of AI models deployed in the region;
providing, by the one or more servers based at least on the determination, a response to the request providing access to the instance of the type of AI model.

15. The method of claim 14, further comprising:
determining, by the one or more servers, whether the request meets one of a rate of calls for the region and a threshold for number of calls for the region per time period; and
providing, by the one or more servers, access to the instance of the type of AI model deployed in the region based on the determining that the request meets the one of the rate of calls for the region and the threshold for the number of calls for the region per time.

16. The method of claim 14, further comprising:
determining, by the one or more servers, whether the request meets one of a rate of calls for the region and a threshold for number of calls for the region per time period; and
determining, by the one or more servers, to provide access to a second instance of the type of AI model in a second region of the plurality of regions responsive to determining that the request does not meet the one of the rate of the calls for the region and the threshold for the number of calls for the region per time.

17. The method of claim 14, further comprising:
identifying, by the one or more servers, based on the request, one or more specifications for one or more AI models of the plurality of AI models; and
identifying, by the one or more servers, based on the one or more specifications, the type of AI model requested.

18. The method of claim 17, further comprising:
identifying, by the one or more servers, using the AI model map, one or more regions of the plurality of regions that provide the instance of the type of AI model; and
selecting, by the one or more servers based on the region of the request, from the one or more regions, a region of the instance of the type of AI model to generate the response.

19. The method of claim 18, wherein the region of the instance of the type of AI model is selected based at least on a proximity between the region of the request and the region of the instance of the type of AI model.

20. A non-transitory computer readable medium storing instructions that, when executed by one or more processors, cause the one or more processors to:
receive a request from a device in a region to access an instance of a type of artificial intelligence (AI) model from a plurality of AI models deployed across a plurality of regions, the one or more processors accessing an AI model map of each instance of an AI model of the plurality of AI models in each region of the plurality of regions based at least on the type of AI model;
identify, based at least on the request, the region of the request and the type of AI model requested;
determine, using the AI model map, the instance of the type of AI model deployed in the region from the plurality of AI models deployed in the region;
provide, based at least on the determination, a response to the request providing access to the instance of the type of AI model.
